(19) United States
(12) Patent Application Publication
(10) Pub. No.: US 2006/0026056 A1
(43) Pub. Date: Feb. 2, 2006

(54) Method and system for information retrieval and evaluation of an organization

(75) Inventors: Bennett Martin Weiner, Arlington, VA (US); Lara Margaret Henry, Arlington, VA (US); Paul Louis Cate, Washington, DC (US); Serigne Mouspatha Ndiaye, Bowie, MD (US); Thomas Christopher Dixon, McLean, VA (US); Howard Christopher Lerman, Vienna, VA (US); Sean Joseph Maclsaac, Reston, VA (US)

Correspondence Address: KING & SPALDING LLP, 191 PEACHTREE STREET, N.E., 45TH FLOOR, ATLANTA, GA, 30303-1763, US

(73) Assignee: Council of Better Business Bureaus, Inc., Arlington, VA (US)

(21) Appl. No.: 11/179,138

(22) Filed: Jul. 12, 2005

Related U.S. Application Data
(60) Provisional application No. 60/592,826, filed on Jul. 30, 2004.

(51) Int. Cl. G07G 1/00

(52) U.S. Cl. 705/10

(57) ABSTRACT

An information retrieval and evaluation system for receiving information about an organization and evaluating the organization based on that information. The information typically includes data retrieved from one or more data bases and organization-related data obtained in a manual fashion by an evaluation system operator. The information can be evaluated against a set of standards in order to determine any problems or concerns that may be associated with the organization. The information received and the information generated from the evaluation can be inserted into a report. The reports of organizations can be published in an online format or obtained using a search method via the Internet, allowing individuals and corporations to review the reports and determine which organizations they want to invest in or support.

### STATEMENT OF RELATED PATENT APPLICATION

This non-provisional patent application claims priority under 35 U.S.C. § 119 to U.S. Provisional Patent Application No. 60/592,826, entitled “Online Charity Reporting and Evaluation System,” filed Jul. 30, 2004. This provisional application and the contents thereof are hereby fully incorporated by reference.

### FIELD OF THE INVENTION

The present invention relates to the field of information retrieval and evaluation. In particular, the invention provides a web-based method and system for obtaining information about an organization and evaluating the organization against one or more standards.

### BACKGROUND OF THE INVENTION

A question often faced by those who provide financial support to charitable organizations is whether a particular organization is legitimate and/or is operating in an ethical and well-managed manner. Charities have grown in number three-fold during the past 25 years from 300,000 in 1980 to over 1,000,000 organizations today. Increasingly, charities also have been in the public spotlight due to concerns raised about how they spend contributed funds, the integrity of their fund raising and how well they are governed. Thus, when individual, corporate, or other donors contemplate contributing to an organization, they seek assurance that the organization is appropriately conducting operations in accordance with their expectations. As it can be difficult for many donors to make this determination on their own especially in light of the growing number of existing charities, they often seek help. Providing an easily accessible evaluation of organizations to determine a charity's accountability would make it easier for donors to make more informed giving decisions and contribute with confidence.

Prior methods of evaluating organizations included making personal contact with a staff member of the charity to request information and materials in order to complete an evaluative report based on a set of comprehensive charity accountability standards addressing charity governance, finances, and fund raising. Typically, an analyst would request a great deal of general documentation from an organization, including incorporation documents, bylaws, tax filings, budgets, fund raising appeals, public service announcement scripts, board roster, annual reports, and audited or unaudited financial data about the organization. An organization would then have to spend time and effort collecting the requested documentation, making copies and forwarding the materials. Once received, the analyst had to review the documentation to determine if the subject charity met specified charity accountability standards. Since document retention and maintenance differ from organization to organization, compiling the information necessary for the evaluation was often time-consuming for the subject charity.

This conventional method of evaluating organizations was inefficient, requiring the analyst to find the answers to open questions based on material included in the documentation. This method also limited the number of organizations that could be evaluated due to the amount of time each evaluation took to complete. The benefit of the evaluation was also limited because some organizations did not want to participate due to the amount of effort and resources that would have to be expended by the organization during the evaluation process. Another problem with the conventional method of evaluating organizations was the amount of storage space necessary to retain the documentation requested from the organization.

In order to overcome some of the problems of the conventional method of evaluating organizations, other methods of evaluation were developed. One evaluation method used by some charity monitoring groups is to solely focus on a few financial ratios. The financial ratios were then converted into a grade or star rating that could be used to compare one organization to another. This method limited the evaluation burden on organizations because the information needed for the evaluation was publicly available in tax forms, thus not requiring the organization to provide it. Further, by limiting the scope of the evaluation, a greater number of organizations could be evaluated by the same number of analysts. In addition, since less documentation was needed, less space was required to store it. However, this evaluation method did have its drawbacks. For example, such evaluations are not as thorough. They provide a narrow view of charity accountability by restricting the evaluation to just certain financial aspects of the organization. An organization may have excellent financial ratios, but may be deficient in other areas of accountability such as self-dealing or misleading appeals.

Another issue that has been raised with charity monitoring organizations is how they can ensure thorough and consistent application of their standards, especially if they seek to significantly increase their volume of their reporting. This concern is magnified if charity evaluations are conducted at more than one office (for example, national and local affiliate offices). Reporting manuals and training have been used but their effectiveness is reliant on the staff that makes use of such tools.

In view of the foregoing, there is a need in the art for a method to allow an organization to quickly and efficiently provide information about itself for evaluation purposes. There is also a need in the art for a method to produce a greater number of organizational evaluations with increased efficiency by automatically evaluating an organization against a set of standards based on information provided by the organization. Additionally, there is a need in the art for the ability to generate reports detailing the results of the evaluation. Furthermore, there is a need in the art for the ability to provide these reports and evaluation data quickly and efficiently for the public at large to use.

### SUMMARY OF THE INVENTION

An information retrieval and evaluation system provides methods and architecture for receiving information about an organization, evaluating the received information against a set of predetermined standards, generating a report summarizing the evaluation results and the information provided by an organization, and making the report available to individuals and corporations via online access.

In support of an evaluation of an organization, the organization prepares a response to a questionnaire. This response typically includes one or more answers to questions contained in the questionnaire. The response can also include documentation or embedded links to information requested within the questionnaire. The questionnaire typically includes multiple questions designed to elicit information about the organization. Any type of question can be included in the questionnaire and typically the questionnaire includes multiple types of questions. The questionnaire can be designed in such a way that for some questions an organization can choose whether it wishes to provide an answer, while for other questions, an answer is required for proper completion of the questionnaire. For example, a question having a mandatory response would require the completing party to provide a response before the next page of questions will be displayed or before the organization will be allowed to complete the questionnaire.

A validation check typically includes an evaluation of the answers provided by an organization to determine if the organization answered all of the questions requiring a response and if the answers are consistent. Consistency of answers can be evaluated by inserting one or more consistency evaluations into the code of the question. Answers of questions that contain a consistency evaluation can then be parsed and evaluated against one another. An automated evaluation can include an evaluation of the answers provided by the organization against a series of standards. Standards typically include business practices and financial situations that are considered beneficial in an organization to ensure legitimate operations. Each standard typically includes one or more evaluation points. The evaluation points can correspond to questions provided in the questionnaire. The answers to the corresponding questions can be compared to the evaluation points to determine if the answer satisfies the evaluation points. Typically, if all of the answers to the corresponding questions satisfy all of the evaluation points, the standard is met by the organization. There is no limit to the breadth and scope of the standards, and the system provides a mechanism for modifying the standards over time.

For one aspect of the present invention, the evaluation system can receive a response from an organization containing answers to a questionnaire. The answers in the response can be checked for errors and inconsistencies in a validation check. The evaluation system can then conduct an automated evaluation of the response against a series of standards to determine the financial health or legitimacy of the organization. A report can be generated describing the organization and the results of the automated evaluation.

For another aspect of the present invention, data previously received or purchased and relevant to an organization can be retrieved from a database. The information can include information about organizations that is capable of being evaluated. The data can be checked for errors and inconsistencies in a validation check. The evaluation system can conduct an automated evaluation of the data against multiple standards having multiple evaluation points. The evaluation system can then generate a report that includes a summary of the evaluation and the retrieved data.

For a further aspect of the present invention, a request can be received by the system for information about organizations. The request typically includes one or more parameters associated with one or many organizations. A search of the database is conducted based on the provided parameters and a list is generated. The list typically includes all of the organizations that satisfy the search parameters. A request for a particular organization can then be received, and the system can retrieve one or more reports for the selected organization.

### BRIEF DESCRIPTION OF DRAWINGS

For a more complete understanding of exemplary embodiments of the present invention and the advantages thereof, reference is now made to the following description in conjunction with the accompanying drawings in which:

FIG. 1 is a block diagram illustrating an exemplary operating environment for implementation of various embodiments of the present invention;

FIG. 2 is a flowchart illustrating a process for organizational reporting and evaluation in accordance with an exemplary embodiment of the present invention;

FIG. 3 is a flowchart illustrating a process for generating a questionnaire in accordance with an exemplary embodiment of the present invention;

FIG. 4 is a flowchart illustrating a process for an organization registering to complete a questionnaire by using the exemplary operating environment in accordance with an exemplary embodiment of the present invention;

FIG. 5 is a flowchart illustrating a process for receiving an organization-generated response to the questionnaire in accordance with an exemplary embodiment of the present invention;

FIG. 6 is a flowchart illustrating a process for conducting a validation check of answers to the questionnaire in accordance with an exemplary embodiment of the present invention;

FIG. 7 is a flowchart illustrating a process for validating information provided in response to the questionnaire in accordance with an exemplary embodiment of the present invention;

FIGS. 8 and 8A are flowcharts illustrating a process for auto-evaluation of submitted responses to the questionnaire against one or more standards in accordance with an exemplary embodiment of the present invention;

FIG. 9 is a flowchart illustrating a process for conducting a secondary review and manual update of responses to the questionnaire in accordance with an exemplary embodiment of the present invention;

FIG. 10 is a flowchart illustrating a process for generating a report of the evaluation of responses to the questionnaire in accordance with an exemplary embodiment of the present invention;

FIG. 11 is a flowchart illustrating a process for organization reporting and evaluation in accordance with an alternate exemplary embodiment of the present invention;

FIG. 12 illustrates a registration user interface for receiving information about an organization in order to access the evaluation system;

FIG. 13 illustrates an exemplary questionnaire user interface for presenting a series of questions that an organization can provide responses to in order to be evaluated;

FIGS. 14 and 14A illustrate an exemplary questionnaire user interface displaying an additional question based on the response provided to the questionnaire;

FIGS. 15, 15A, and 15B illustrate an exemplary report user interface generated by the evaluation system based on responses received and an evaluation of one or more standards;

FIG. 16 illustrates an exemplary documentation request user interface displaying a request for additional documentation based on responses provided in the questionnaire;

FIGS. 17 and 17A illustrate an exemplary standards user interface displaying the standard and the evaluation points to be evaluated for that standard; and

FIG. 18 is a flowchart illustrating a process for retrieving an evaluation of an organization via a web-based system in accordance with an exemplary embodiment of the present invention.

### DETAILED DESCRIPTION OF THE EXEMPLARY EMBODIMENTS

The present invention supports a computer-implemented method and system for online reporting of financial and operational information by organizations, evaluating the information provided against one or more standards, and generating a report based on the evaluation. Exemplary embodiments of the invention can be more readily understood by reference to the accompanying figures.

Although exemplary embodiments of the present invention will be generally described in the context of a software module and an operating system running on a personal computer, those skilled in the art will recognize that the present invention can also be implemented in conjunction with other program modules for other types of computers. Furthermore, those skilled in the art will recognize that the present invention may be implemented in a stand-alone or in a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description that follows is represented largely in terms of processes and symbolic representations of operations by conventional computer components, including processing units, memory storage devices, display devices, and input devices. These processes and operations may utilize conventional computer components in a distributed computing environment.

The processes and operations performed by the computer include the manipulation of signals by a processing unit or remote computer and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

Exemplary embodiments of the present invention include a computer program that embodies the functions described herein and illustrated in the appended flowcharts. However, it should be apparent that there could be many different ways of implementing the invention in computer programming, and the invention should not be construed as limited to any one set of computer program instructions. Further, a skilled programmer would be able to write such a computer program to implement a disclosed embodiment of the present invention without difficulty based, for example, on the flowcharts and associated description in the application text. Therefore, disclosure of a particular set of program code instructions is not considered necessary for an adequate understanding of how to make and use the present invention. The inventive functionality of the computer program will be explained in more detail in the following description and is disclosed in conjunction with the remaining figures illustrating the program flow.

Referring now to the drawings, in which like numerals represent like elements throughout the several figures, aspects of the present invention and an exemplary operating environment for the implementation of the present invention will be described.

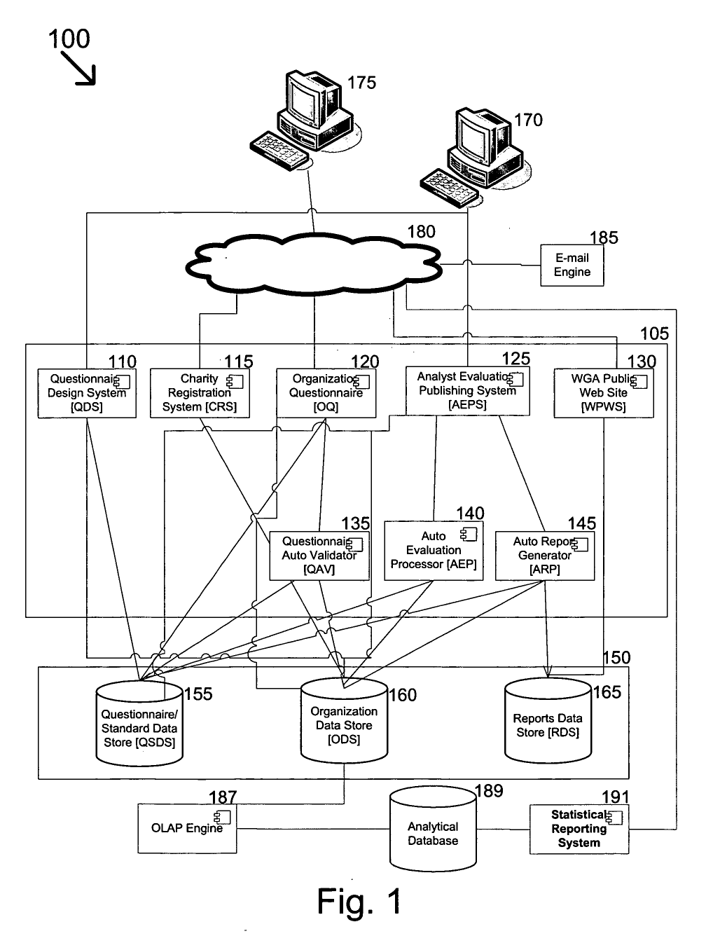

FIG. 1 is a block diagram illustrating an information receiving and organizational evaluation system 100 constructed in accordance with an exemplary embodiment of the present invention. The exemplary system 100 comprises an evaluation system 105, a data storage system 150, an evaluation workstation 170, a workstation 175, an electronic mail (“e-mail”) engine 185, an OLAP engine 187, an organization analytical database 189, and a statistical reporting system 191. The evaluation system 105, data storage system 150, e-mail engine 185, OLAP engine 187, organization analytical database 189, and statistical reporting system 191 can reside either at a local computing environment, such as a evaluation workstation 170, or at one or more remote locations, such as a remote server.

The evaluation workstation 170 is communicably attached via a distributed computer network to the evaluation system 105. In one exemplary embodiment, the evaluation workstation 170 is a personal computer. The evaluation system 105 is communicably attached via a distributed computer network to the workstation 175, evaluation workstation 170, e-mail engine 185, and data storage system 150. The exemplary evaluation system 105 comprises a questionnaire design system (“QDS”) 110, an organization registration system (“CRS”) 115, an organization questionnaire (“OQ”) 120, an analyst evaluation publishing system (“AEPS”) 125, a WGA public website (“WPWS”) 130, a questionnaire auto-validator (“QAV”) 135, an auto-evaluation processor (“AEP”) 140, and an auto-report generator (“ARP”) 145.

The data storage system 150 is communicably attached via a distributed computer network to the evaluation system 105 and the OLAP engine 187. The exemplary data storage system 150 includes a questionnaire and standards data store (“QSDS”) 155, an organization data store (“ODS”) 160, and a reports data store (“RDS”) 165. In one exemplary embodiment, the data storage system 150 is a database comprising the data stored in the QSDS 155, ODS 160, and RDS 165.

The QDS 110 is communicably attached via a distributed computer network to the QSDS 155, the ODS 160, and the evaluation workstation 170. In one exemplary embodiment, the QDS is a web-based computer application that allows an analyst or network administrator to generate or modify a questionnaire or generate or modify one or more standards used to evaluate the questionnaire and store the questionnaire or standard in the QSDS 155. In one exemplary embodiment, the QDS 110 transmits questions, validation conditions, standards, evaluation points, and basic language to be inserted into a report to the QSDS 155.

The CRS 115 is communicably attached via a distributed computer network to the workstation 175, the ODS 160, and the e-mail engine 185. The CRS is a COM object capable of receiving registration information from an organization through the workstation 175 and storing the registration information in the ODS 160. The CRS is also capable of passing registration information to the e-mail engine 185, which can generate and send an email to an organization at the workstation 175. In one exemplary embodiment, the CRS 115 publishes a user interface on a website that is accessible via the workstation 175 through the Internet 180. This user interface is useful for receiving registration information for an organization. The registration information can include the name of the organization, its address, phone number, e-mail address, and a password for logging into the evaluation system 105 at a subsequent point in time.

The OQ 120 can be communicably attached via a distributed computer network to the workstation 175, the QAV 135, the QSDS 155, the ODS 160, and the e-mail engine 185. The OQ 120 is a COM object capable of receiving a questionnaire from the QSDS 155, receiving responses to the questionnaire from the workstation 175 via the Internet 180, passing the responses to the QAV 135 for a validation check, and storing the responses in the ODS 160. The AEPS 125 is communicably attached via a distributed computer network to the evaluation workstation 170, the e-mail engine 185, the AEP 140, the ARP 145, the QSDS 155, and the ODS 160. The AEPS 125 is a COM object capable of retrieving data from the QSDS 155 and the ODS 160 and displaying the data on the evaluation workstation 170. The AEPS can also transmit changes made to an evaluation to the AEP 140 and the ARP 145. In one exemplary embodiment, the AEPS 125 generates and displays a web page on the evaluation workstation 170 for receiving changes to an evaluation. In another exemplary embodiment, the AEPS 125 can transmit changes to responses to the questionnaire to the ODS 160. Furthermore, in the exemplary embodiment, the data received by the AEPS 125 from the QSDS 155 includes questions, standards, evaluation points, and relationships of questions, while the data received from the ODS 160 includes responses to the questionnaire and automatic evaluations. The AEPS 125 is also capable of sending an e-mail to the workstation 175 using the e-mail engine 185.

The WPWS 130 is communicably attached via a distributed computer network to the workstation 175 and the RDS 165. The WPWS 130 is a COM object capable of generating and displaying a web page on the workstation through the Internet 180 to allow a user to request information regarding an organization. The WPWS 130 can retrieve information about the organization, including a report from the RDS 165, and display it on the workstation 175. The QAV 135 is communicably attached via a distributed computer network to the OQ 135, the QSDS 155, and the ODS 160. The QAV 135 is a COM object capable of receiving validation logic from the QSDS 155 and responses from the ODS 160 to review the responses to determine if they are valid, then passing the results of the validation check to the OQ 120.

The AEP 140 is communicably attached via a distributed computer network to the AEPS 125, the QSDS 155, and the ODS 140. The AEP 140 is a COM object capable of receiving a set of standards and evaluation points from the QSDS 155, receiving responses from the ODS 160, and conducting an automated evaluation of these responses to determine if they meet the standards. The AEP can then store the results of the evaluation in the ODS 160. The ARP 145 is communicably attached via a distributed computer network to the AEPS 125, the QSDS 155, the ODS 160, and the RDS 165. The ARP 145 is a COM object capable of receiving standards and basic text from the QSDS 155 and evaluation results and responses from the ODS 160, and generating a report on an organization, which can be stored in the RDS 165.

The QSDS 155 is communicably attached via a distributed computer network to the QDS 110, OQ 120, AEPS 125, QAV 135, AEP 140, and the ARP 145. The QSDS 155 typically contains questions, answer logic, standards, evaluation points, basic “does not meet” language, and documentation types. In one exemplary embodiment, the QSDS 155 is a SQL server database. The ODS 160 is communicably attached via a distributed computer network to the QDS 110, CRS 115, OQ 115, AEPS 125, QAV 135, AEP 140, ARP 145, and OLAP engine 187. The ODS 160 can contain responses to the questionnaire, e-mail correspondence with the organization, supplemental documentation provided by the organization, and results of the evaluation of the responses. In one exemplary embodiment, the ODS 160 is a SQL server database. The RDS 165 is communicably attached via a distributed computer network to the WPWS 130 and ARP 145. The RDS 165 typically contains reports on organizations generated by the ARP 145. In one exemplary embodiment, the RDS 165 is a SQL server database.

An evaluation workstation 170 is communicably attached via a distributed computer network to the QDS 110 and AEPS 125. The evaluation workstation 170 typically allows an analyst or administrator to create questionnaires and standards and evaluate responses to registrations and questionnaires. In one exemplary embodiment, the evaluation workstation 170 is a personal computer.

An OLAP engine 187 is communicably attached via a distributed computer network to the ODS 160 and the analytical database 189. The OLAP engine 187 typically provides a mechanism for manipulating data from a variety of sources that has been stored in a database, such as the ODS 160. The OLAP engine 187 can allow a user at the workstation 175 to conduct statistical evaluations of the responses stored in the ODS 160. The user can access the OLAP engine 187 through a web page generated by the statistical reporting system 191. Results of the statistical analysis can be stored in the analytical database 189. In one exemplary embodiment, the statistical reporting system 191 is a COM object and the analytical database 189 is a SQL server database.

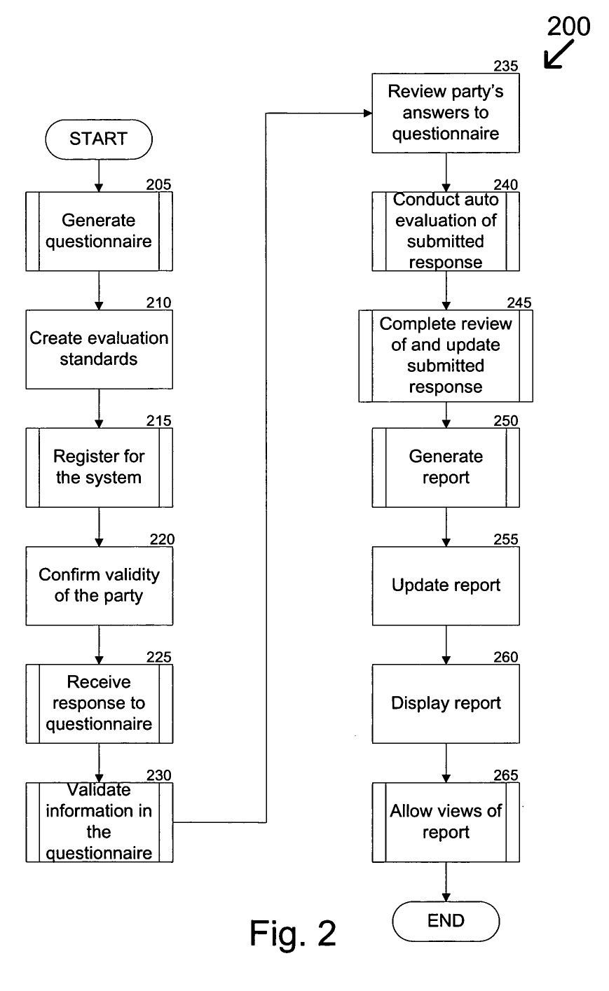

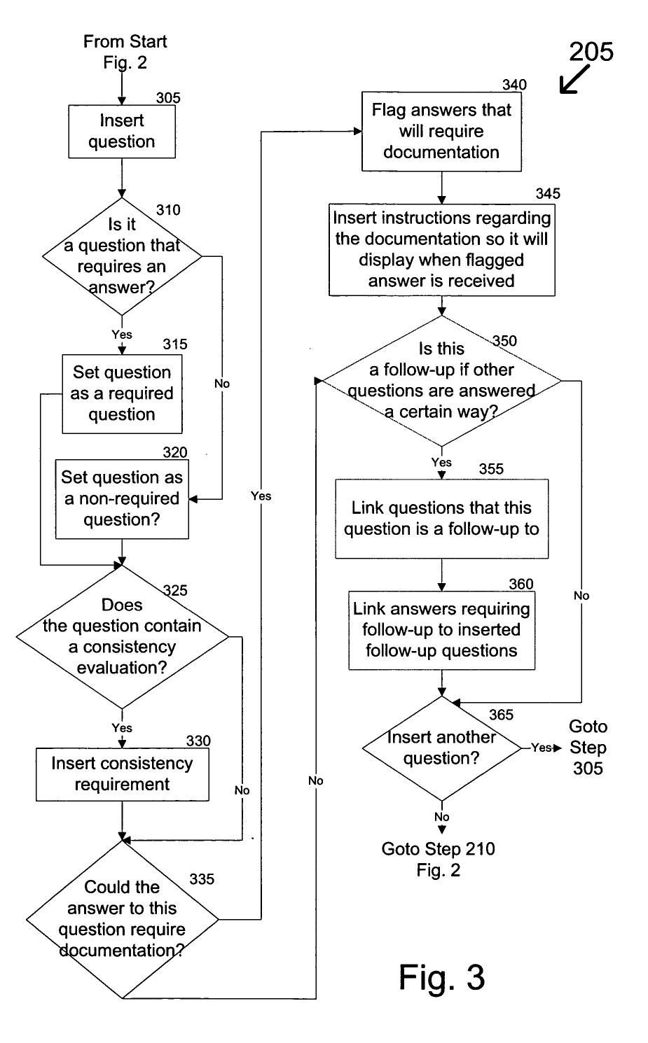

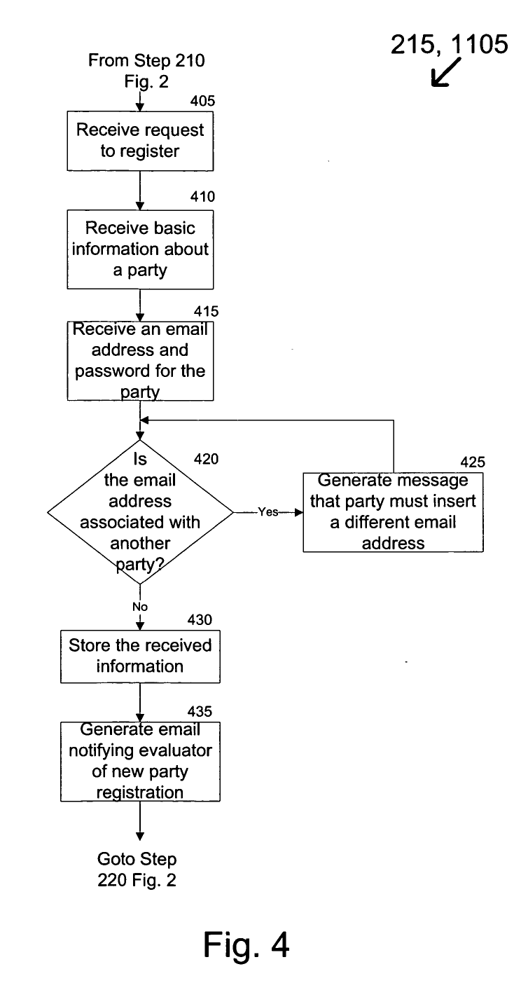

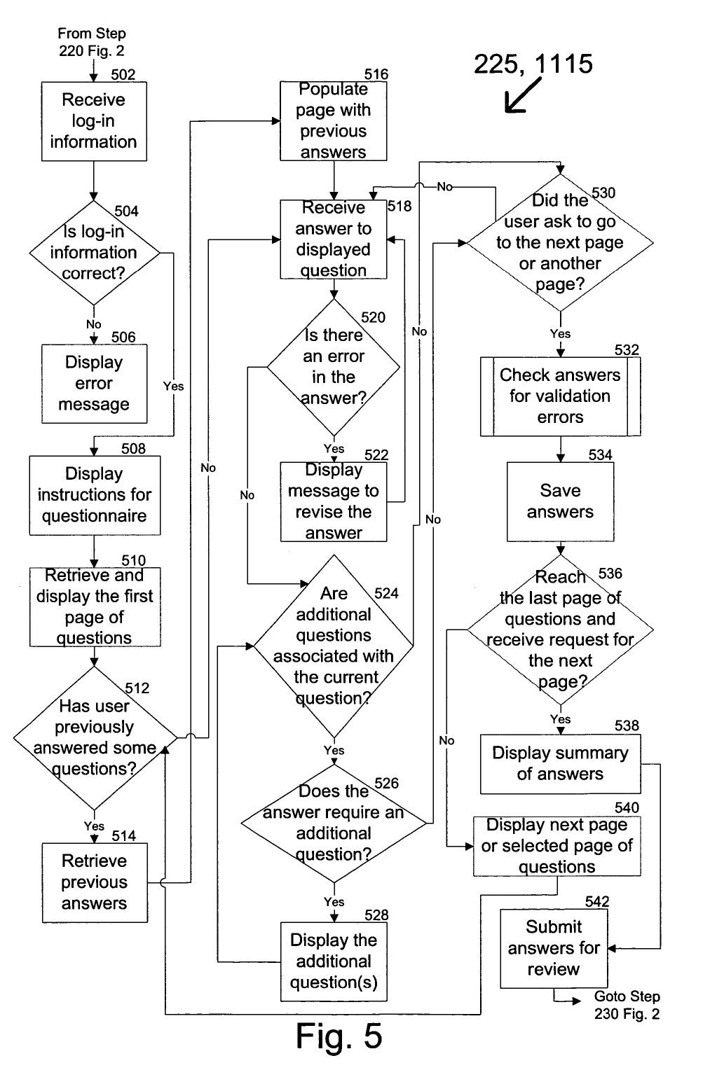

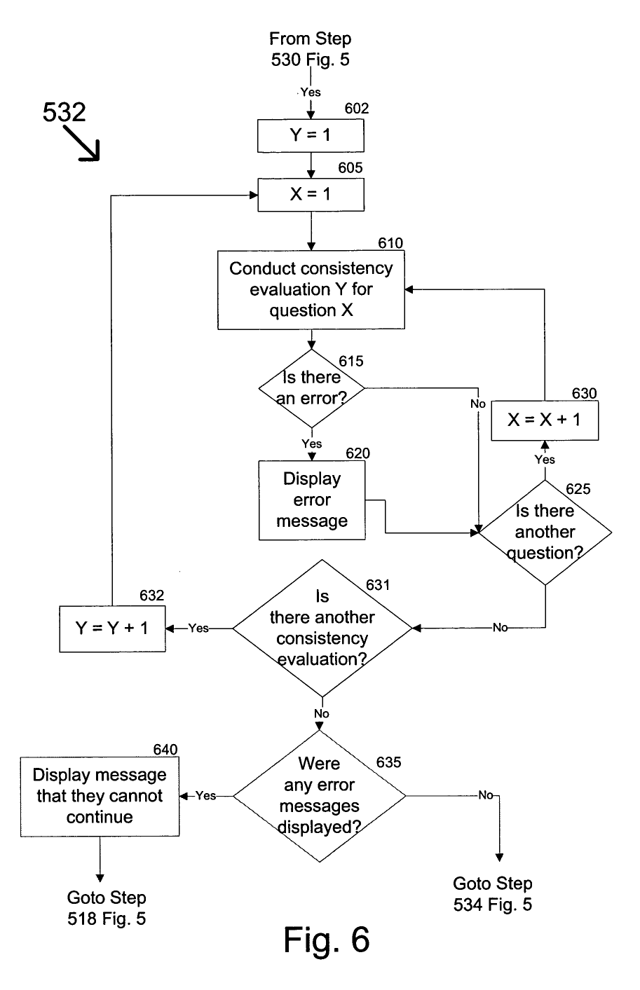

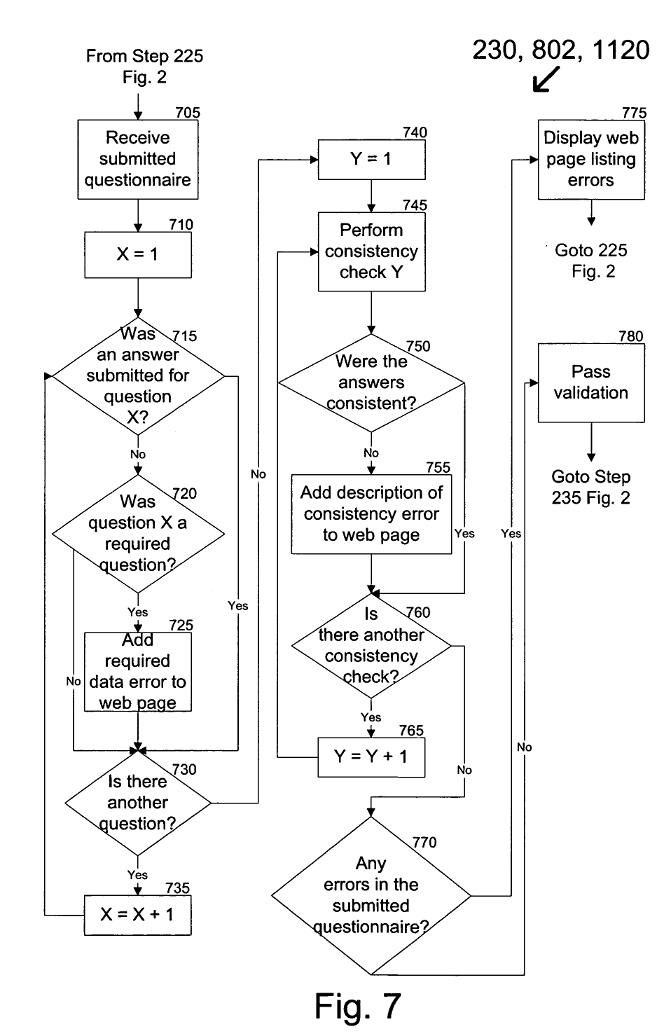

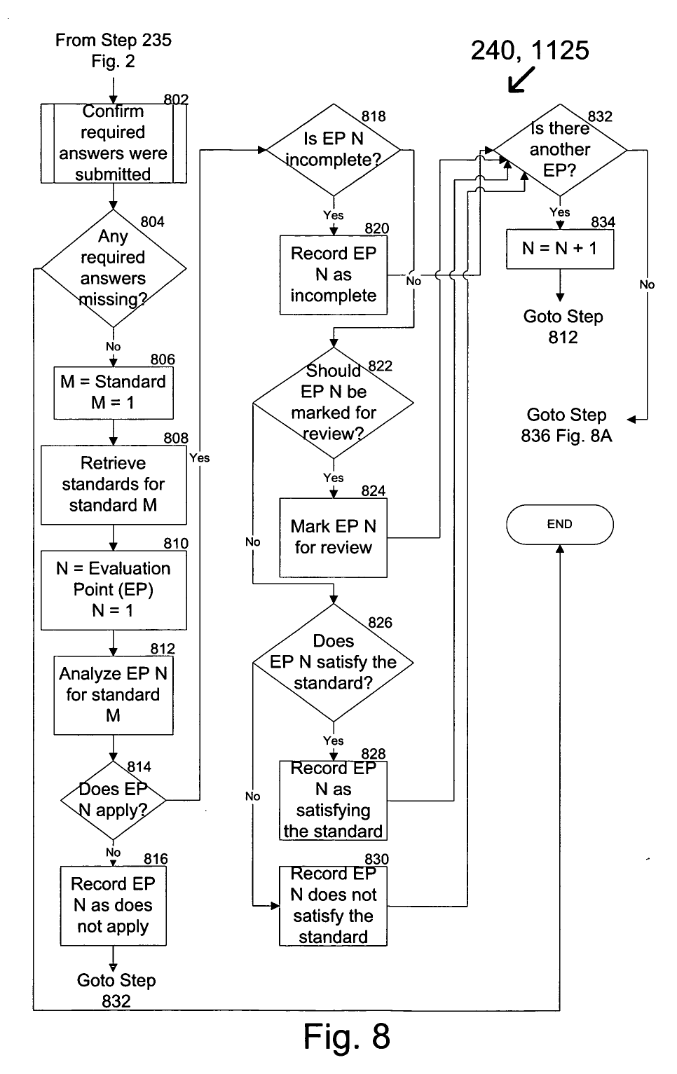

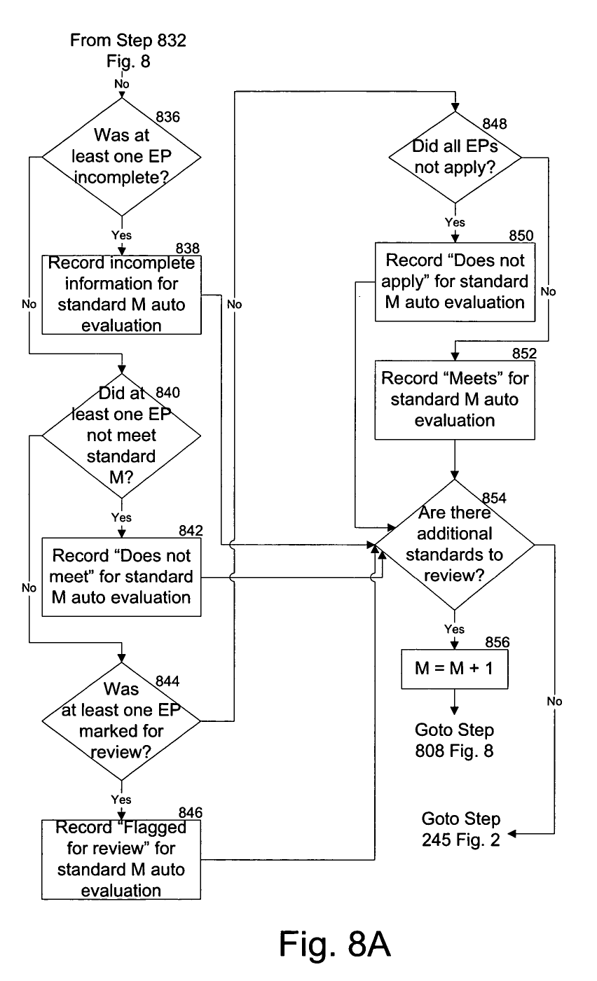

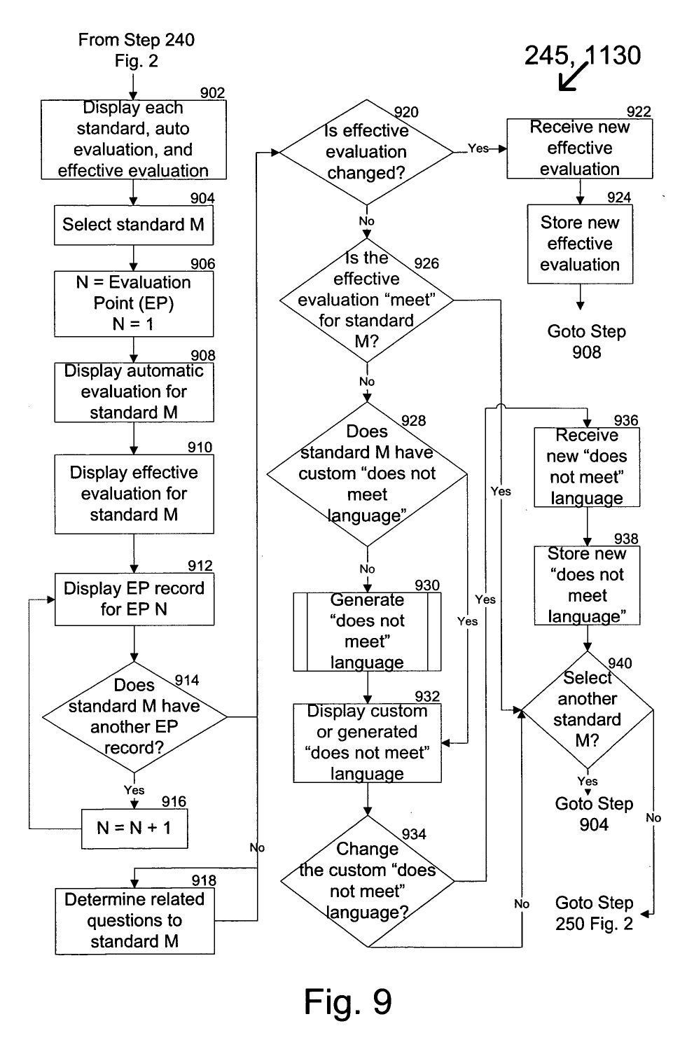

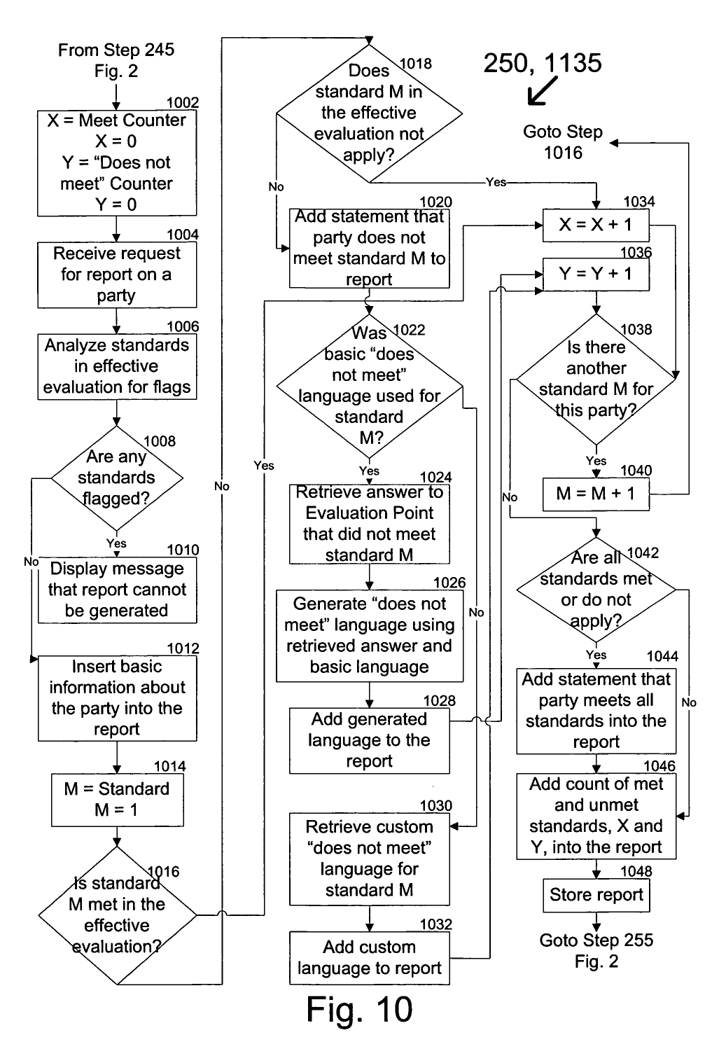

FIGS. 2-11 and 18 are logical flowchart diagrams illustrating the computer-implemented processes completed by exemplary methods for receiving and evaluating information in response to an online organization questionnaire. While the exemplary methods could apply to any type of organization or business structure, including for-profit and not-for-profit entities, the exemplary methods below will be described in relation to an evaluation of a charity in response to receiving a response to the exemplary online questionnaire. FIG. 2 is a logical flowchart diagram presented to illustrate the general steps of an exemplary process 200 for receiving and evaluating information provided in a response to an online organization questionnaire, within the operating environment of the exemplary automated evaluation system 100 of FIG. 1.

Now referring to FIGS. 1 and 2, the exemplary method 200 begins at the START step and proceeds to step 205, in which a questionnaire is generated. In one exemplary embodiment, the questionnaire can be input from the evaluation workstation 170 through the QDS 110 and stored in the QSDS 155. The questionnaire can include requests for general information, such as name, address, contact information, financial information, operational information, and other similar attributes of a charity.

In step 210, a system administrator can create one or more evaluation standards that can be input into the system 100 from the evaluation workstation 170 through the QDS 110 and stored in the QSDS 155. In one exemplary embodiment, evaluation standards can include the following: a board of directors that provides adequate oversight of the charity's operation; a board of directors with a minimum of five voting members; a minimum of three board meetings per year that include the full governing body having a majority in attendance and meeting face-to-face; no more than 10 percent of the board can be compensated by the charity; assessing the charity's performance at least every two years; submitting a report to the governing body describing the charity's performance and providing recommendations for the future; at least 65 percent of expenses go towards program activities; less than 35 percent of contributions can be used for fundraising; and financial statements prepared according to GAAP and available upon request.

A charity seeking to be evaluated can register on the system 100 in step 215. Registration on the system 100 can be initiated from the workstation 175 through the Internet 180 and CRS 115. Registration information is typically stored in the ODS 160 and can include the name of the charity that is registering, an e-mail address or other contact information, and a password for subsequent entry into the system 100. In step 220, the validity of the registering charity is verified. The verification of a charity typically includes determining if the organization is a legitimate business entity or organization and if the organization has previously registered for an evaluation. Validation of a charity can be completed by matching information maintained in databases or by manual review. In one exemplary embodiment, the CRS 115 passes registration information from the ODS 160 to the evaluation client 185, where validation of a charity is determined by an analyst who manually determines if the charity submitting the request is a soliciting organization.

In step 225, the automated evaluation system 100 receives a response to the questionnaire from the workstation 175 at the OQ 120. The QAV 135 in step 230 validates information contained in the response. In step 235, the response is reviewed to determine if the proper answer types have been provided by the responding charity. In one exemplary embodiment, the AEPS passes the response from the ODS 160 to the evaluation workstation 170 where an analyst determines if proper answer types have been provided.

In step 240, the AEP 140 conducts an automated evaluation of the response to determine if the questionnaire responses meet one or more of the standards stored in the QSDS 155. The ARP 145 in step 250 generates a report. The report typically includes the responses provided by the charity, each of the standards used for comparison to the responses and whether the charity met, failed to meet, or did not provide enough information to determine if the charity met the standards. In step 255, the report can be updated or modified. In one exemplary embodiment, the report is modified by an analyst through the evaluation workstation 170 and the AEPS 125. The modified report is displayed on the evaluation workstation 170 in step 260. In step 265, the report can be stored in the RDS 165 and can be viewed by the workstation 175 by making a request through the WPWS 130. The exemplary process terminates at the END step. The tasks completed in steps 205, 215, 225, 230, 240, 245, and 250 are described in more detail below in connection with FIGS. 3, 4, 5, 7, 8, 8A, 9, and 10.

FIG. 3 is a logical flowchart diagram illustrating an exemplary computer-implemented method for generating an online questionnaire as completed by step 205 of FIG. 2. Referencing FIGS. 1, 2, and 3, the exemplary method 205 begins with an administrator inserting a question to be displayed by the system 100 into the QDS 110. The system 100 is designed to accept a large variety of types of questions. In one exemplary embodiment, the types of questions that can be inserted include: yes or no questions; questions seeking an answer in date form; multiple choice questions; questions seeking an answer in numeric form; questions seeking an answer containing a URL; questions containing a drop-down list of answers; questions allowing for a free-form response in sentence format; questions that contain child sponsorship organization questions; read-only questions that contain embedded schema for generating an answer based on responses to other questions. In step 310, an inquiry is conducted to determine if the inserted question is one that requires an answer. In one exemplary embodiment, the questionnaire can have many questions. The administrator can determine that a charity must provide a response to some questions, thus making them required, before continuing to the next page of the questionnaire or completing the questionnaire. On the other hand, the administrator can determine that answers to other questions are beneficial to the evaluation, but not necessary, thus making them not required. If the question is required, the “Yes” branch is followed to step 315, where the question is set as a required question. In one exemplary embodiment, a question becomes a required question by setting a flag designating the question as required in the QDS 110, using the evaluation workstation 170. If the question is not a required question, the “No” branch is followed to step 320, where the question is designated as not requiring an answer.

An inquiry is conducted in step 325 to determine if the question contains a consistency evaluation. In one exemplary embodiment, a question contains a consistency evaluation if the question includes conditions that must be met in order for the answer to be considered consistent. The conditions are typically embedded as SQL code. If the question contains a consistency check, the “Yes” branch is followed to step 330, where the consistency conditions are inserted. Otherwise, the “No” branch is followed to step 335.

In step 335, an inquiry is conducted to determine if answers to the question may require the charity to supply additional documentation. Additional documentation may be required to better explain the basis for an answer to a question or to provide supplemental proof that the answer is correct. In one exemplary embodiment, a question seeking information related to income tax filings can also ask the charity to supply a copy of income tax forms filed with the IRS or state agencies. If an answer to the question could require documentation, the “Yes” branch is followed to step 340, where the question is flagged at the QDS 110 by the administrator, via the evaluation workstation 170. The process continues to step 345, where the administrator inserts instructions through the evaluation workstation 170 into the QDS 110 regarding the required documentation so that the request for documentation will display when the OQ 120 receives a particular type of answer. FIG. 16 illustrates an exemplary documentation request user interface displaying a request for additional documentation. As shown in the exemplary user interface of FIG. 16, documentation can be sent, when requested, in electronic format, sent at a subsequent time either in electronic format or using conventional mailing techniques, or a charity can answer that the requested documentation is not available. Returning to FIG. 3, if answers to the question will not require documentation, the “No” branch is followed to step 350.

An inquiry is conducted in step 350 to determine if this question is a follow-up question to another question and will only be displayed if particular types of answers are provided in response to the question. Instead of requesting supporting documentation, when particular answers are provided to specific questions, one or more additional questions can be retrieved from the QSDS 155 by the OQ 120 and displayed on the workstation 175. If the current question is a follow-up question, the “Yes” branch is followed to step 355, where one or more questions that the current question is a follow-up to are linked by the administrator at the QDS 110 via the evaluation workstation 170. In step 360, answers that will cause the current question to be displayed are linked to the current question in the QDS 110 by an administrator through the evaluation workstation 170. The process continues to step 365.

If the current question is not a follow-up question in step 350, the “No” branch is followed to step 365. The questions are typically stored in the QSDS 155. An inquiry is conducted in step 365 to determine if another question is being input into the QDS 110 from the evaluation workstation 170. If another question is being input, the “Yes” branch returns to step 305. Otherwise, the “No” branch is followed to step 210 of FIG. 2.

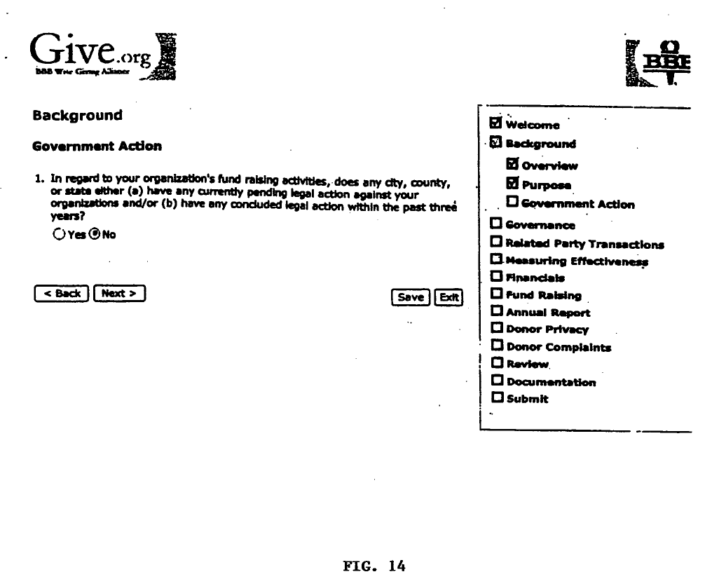

FIG. 4 is a logical flowchart diagram illustrating an exemplary computer-implemented method for a charity registering with the system 100 as completed by step 215 of FIG. 2. Referencing FIGS. 1, 2, and 4, the exemplary method 215 begins with the CRS 115 receiving a request to register with the system 100 from the workstation 175 in step 405. In one exemplary embodiment, a charity can select a link on a web page connected to the CRS 115 via the Internet 180 in order to initiate the registration process. In step 410, the CRS 115 accepts general background information about the charity. In one exemplary embodiment, the background information may include the name of the charity, the address of the charity, and a method of contacting the charity, such as a phone number; however, other types of background information are contemplated. FIG. 12 illustrates an exemplary user interface for receiving registration information. In the exemplary user interface of FIG. 12, the data solicited includes the name of the charity as well as the physical address, phone number, website, year of incorporation, and state of incorporation for the charity.

The CRS 115 in step 415 receives an e-mail address and password for the charity. In one exemplary embodiment, the e-mail address can be inserted into a request box on a web page and transmitted to the CRS 115 with the workstation 175. An inquiry is conducted in step 420 to determine if the e-mail address received by the CRS 115 is associated with a different charity. The determination can be made by the CRS 115 evaluating the ODS 160 for the e-mail address received in step 415. If the address is already located in the ODS 160, the CRS 115 can determine if the same charity previously provided that e-mail address. If the e-mail address is associated with a different charity, the “Yes” branch is followed to step 425, where the CRS 115 generates a message to be displayed on the workstation 175 that the charity must insert a different e-mail address. The process then returns to step 415.

If the e-mail address is not associated with a different charity, the “No” branch is followed to step 430, where the registration information is stored in the ODS 160. In step 435, the e-mail engine 185 generates an e-mail message notifying an analyst that a new charity has registered for the system. In one exemplary embodiment, the message is sent from the e-mail engine 185 to the evaluation workstation 170, where it is displayed. The process continues to step 220 of FIG. 2.

FIG. 5 is a logical flowchart diagram illustrating an exemplary computer-implemented method for displaying a questionnaire as completed by step 225 of FIG. 2. Referencing FIGS. 1, 2, and 5, the exemplary method 502 begins with the OQ 120 receiving login information from the workstation 175. In one exemplary embodiment, the login information includes the e-mail address of the charity attempting to login and the password previously provided by the charity during the registration process. An inquiry is conducted in step 504 to determine if the login information is correct. The OQ 120 typically compares the login information received from the workstation 175 to information stored in the ODS 160. If the login information is not correct, the “No” branch is followed to step 506, where an error message is generated by the OQ 120 and displayed at the workstation 175. Otherwise, the “Yes” branch is followed to step 508, where the OQ 120 retrieves instructions for responding to the questionnaire from the QSDS 155 and displays them on the workstation 175.

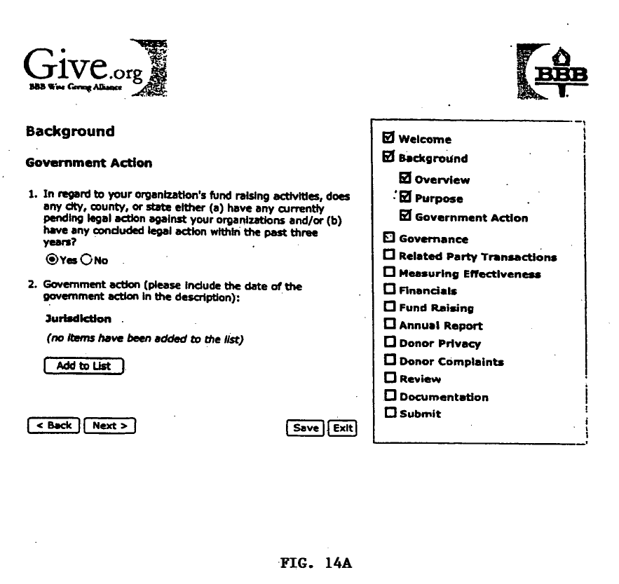

In step 510, the OQ 120 retrieves the first page of questions in the questionnaire from the QSDS 155 and displays the page on the workstation 175. FIG. 13 illustrates an exemplary questionnaire user interface displaying a page of questions. An inquiry is conducted in step 512 to determine if the charity has previously provided answers to some of the questions in the questionnaire. In one exemplary embodiment, the OQ 120 can ping the ODS 160 to determine if answers for the charity are already stored there. If the charity has previously provided answers to one or more of the questions in the questionnaire, the “Yes” branch is followed to step 514, where the OQ 120 retrieves the previous answers provided for the current page from the ODS 160 and populates the questions with those answers at the workstation 175 in step 516. However, if answers have not previously been provided by the charity, the “No” branch is followed to step 518, where an answer to a displayed question is received from the workstation 175.

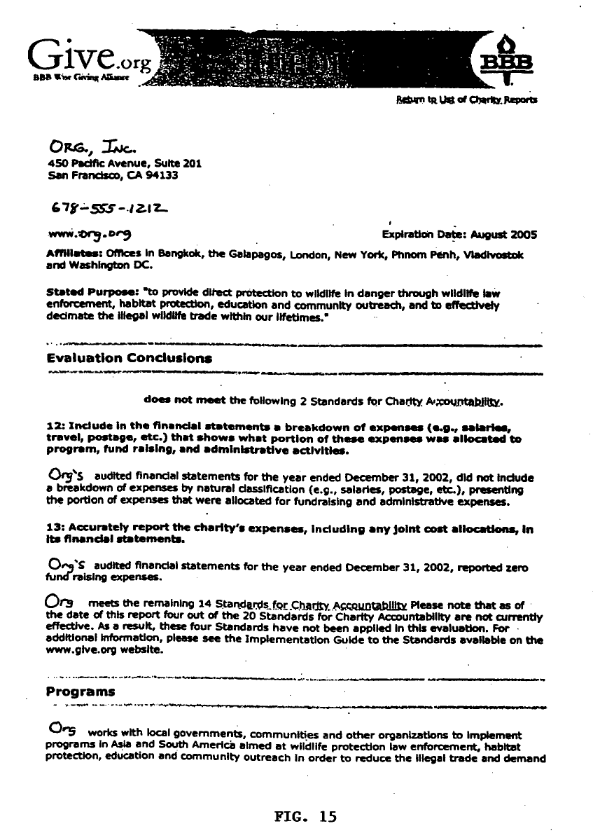

An inquiry is conducted in step 520 to determine if the form of the answer is in error. In one exemplary embodiment, the OQ 120 can determine if the form of answer that should be received does not match the form of the answer received. For example, an error would be generated if the anticipated answer was numerical but the answer provided was a word or phrase. If the answer contains an error, the “Yes” branch is followed to step 522, where the OQ 120 generates an error message and displays it on the workstation 175, requesting the charity to revise the answer. The process returns to step 518. If there is no error, the “No” branch is followed to step 524, where an inquiry is conducted to determine if additional questions are associated with the current question. The OQ 120 determines if additional questions are associated with the current question by evaluating the QSDS 155 to see if questions were linked together as discussed in step 355 of FIG. 3. The exemplary questionnaire user interface displays of FIGS. 14 and 14A present one example of how a particular response to a question can generate additional questions. As can be seen in FIG. 14, if a charity responds “No” to the question, no additional questions are displayed. On the other hand, as can be seen in the exemplary display of FIG. 14A, when a charity responds “Yes” to the same question, an additional question is displayed for the charity to respond to.

Retuning to FIG. 5, if no additional questions are associated with the current question, the “No” branch is followed to step 530. Otherwise, the “Yes” branch is followed to step 526, where an inquiry is conducted to determine if the answer provided by the charity to the current question requires the display of additional questions. As discussed in step 360 of FIG. 3, certain answers can be linked in the QDS 110 to follow-up questions and stored in the QSDS 155. The OQ 120 can compare the answer provided by the charity to answers linked to follow-up questions in the QSDS to determine if follow-up questions should be displayed at the workstation 175. If the answer provided by the charity does not require a follow-up question, the “No” branch is followed to step 530. Otherwise, the “Yes” branch is followed to step 528, where the OQ 120 displays the follow-up questions retrieved from the QSDS 155 on the workstation 175. The process then returns to step 524.

In step 530, an inquiry is conducted to determine if the charity has asked to go on to the next or another page. In one exemplary embodiment, the user can select a “Next” button on the website that comprises a link allowing the charity to move to the next page of the questionnaire or the charity can select a specific page to view next. The exemplary questionnaire user interface of FIG. 13 shows one method that a charity may use to select where it wants to go next. In the exemplary questionnaire of FIG. 13, “Back” and “Next” buttons are provided, giving the charity the ability to go forward or backwards in the questionnaire. On the right side of the interface is a menu that the charity can select to link to a different section of the questionnaire, instead of going one page at a time. If the user has not asked to go to the next or another page, the “No” branch is followed to step 518 to receive an answer to another displayed question. Otherwise, the “Yes” branch is followed to step 532, where the QAV 135 checks the answers on the current page for validation errors. In one exemplary embodiment, validation errors include providing inconsistent answers to containing a consistency requirement. In step 534, the OQ 120 saves the current page of answers in the ODS 160.

An inquiry is conducted in step 536 to determine if the charity has reached the last page of the questionnaire and then requested the next page. If not, the “No” branch is followed to step 540, where the OQ 120 retrieves the next page of questions from the QSDS 155 and displays them on the workstation 175. The process then returns to step 512. Otherwise, the “Yes” branch is followed to step 538, where the OQ 120 retrieves a summary of the answers provided by the charity form the ODS 160 and displays them on the workstation 175. In step 542, the charity submits the answers for review. In one exemplary embodiment, the answers can be submitted for review by selecting a link on the website at the workstation 175. In another exemplary embodiment, the charity cannot submit its answers for review unless it agrees to a click-wrap license that is displayed when the charity tries to submit its answers for review. The charity can typically agree to the click-wrap license agreement by selecting a link designated “Agree” and simultaneously submitting the answers for review. The process continues to step 230 of FIG. 2.

FIG. 6 is a logical flowchart diagram illustrating an exemplary method for conducting a validation check of answers to the questionnaire as completed by step 532 of FIG. 5. Now referring to FIGS. 1, 5, and 6, the exemplary method 532 begins with counter variable Y being set equal to one in step 602. In step 605, the counter variable X is set equal to one. In step 610, the QAV 135 retrieves consistency check one for the current page from the QSDS 155. The QAV 135 determines whether the consistency check is met by retrieving the answers to questions containing a consistency evaluation from the ODS 160 and evaluating the retrieved answers for consistency.

An inquiry is conducted in step 615 to determine if there is a validation error. If so, the “Yes” branch is followed to step 620, where the QAV 135 generates an error message and displays it on the workstation 175. Otherwise, the “No” branch is followed to step 625, where an inquiry is conducted to determine if there is another question on the current page. If so, the “Yes” branch is followed to step 630, where the counter variable X is incremented by one. The process then returns to step 610. If no additional questions remain on the page, the “No” branch is followed to step 631.

In step 631, an inquiry is conducted to determine if there is another consistency check to conduct on the questions on this page. If so, the “Yes” branch is followed to step 632, where the counter variable Y is incremented by one. The process then returns to step 605. If there are no additional consistency checks for this page, the “No” branch is followed to step 635. In step 635, an inquiry is conducted to determine if the QAV 135 displayed any error messages on the workstation 175. If so, the “Yes” branch is followed to step 640, where the QAV 135 generates a message that the charity cannot continue and displays the message on the workstation 175. The process continues to step 518 of FIG. 5. However, if the QAV 135 did not display any error messages, the “No” branch is followed to step 534 of FIG. 5.

FIG. 7 is a logical flowchart diagram illustrating an exemplary computer-implemented method for validating answers provided in response to a questionnaire as completed by step 230 of FIG. 2. Now referring to FIGS. 1, 2 and 7, the exemplary method 230 begins at step 705, where the QAV 135 receives a submitted questionnaire from the OQ 120. The submitted questionnaire will typically have one or more answers that have been provided in response to the questions presented in the questionnaire. In step 710, counter variable X is set equal to one. In step 715, an inquiry is conducted to determine if an answer was submitted for question one of the questionnaire. If not, the “No” branch is followed to step 720, where an inquiry is conducted to determine if question one is a required question. The QAV 135 typically determines if the question is a required question by analyzing the QSDS 155 to determine if the current question was flagged as a required question at the QDS 110. If question one was a required question, the “Yes” branch is followed to step 725, where the OQ 120 generates an error message that required data was not provided for this particular question. Otherwise, the “No” branch is followed to step 730. Returning to step 715, if an answer was provided for question one, the “Yes” branch is followed to step 730.

An inquiry is conducted in step 730 to determine if there is another question to evaluate. Typically, the QAV 135 retrieves the questionnaire from the QSDS 155 to determine if there is another question to evaluate. If there is another question to evaluate, the “Yes” branch is followed to step 735, where the variable X is incremented by one. The process then returns to step 715. However, if there are no other questions to evaluate, the “No” branch is followed to step 740, where the counter variable Y is set equal to one. In step 745, the QAV 135 performs a first consistency check. In performing the consistency check, the QAV 135 typically retrieves the answers for a charity from the ODS 160 and reviews which questions contain a consistency evaluation in the QSDS 155. The QAV 135 then determines if the answers to the questions containing the consistency evaluation are consistent.

In step 750, an inquiry is conducted to determine if the answers are consistent for the first consistency check. If not, the “No” branch is followed to step 755, where the OQ 120 generates an error message stating that a consistency error exists for that particular consistency check. Otherwise, the “Yes” branch is followed to step 760, where an inquiry is conducted to determine if there is another consistency check to complete. If so, the “Yes” branch is followed to step 765, where the counter variable Y is incremented by one. The process then returns to step 745. If the last consistency check has been completed, then the “No” branch is followed to step 770.

In step 770, an inquiry is conducted to determine if the QAV 135 has generated any error messages for the submitted questionnaire. In one exemplary embodiment, error messages generated by the OQ 120 in steps 725 and 755 can be stored in a queue of the OQ 120. If error messages have been generated by the QAV 135, the “Yes” branch is followed to step 775, where the OQ 120 displays a web page listing the error messages on the workstation 175. The process then continues to step 225 of FIG. 2. If the OQ 120 does not generate any error messages, the “No” branch is followed to step 780, where the validation is passed. The process then continues to step 235 of FIG. 2.

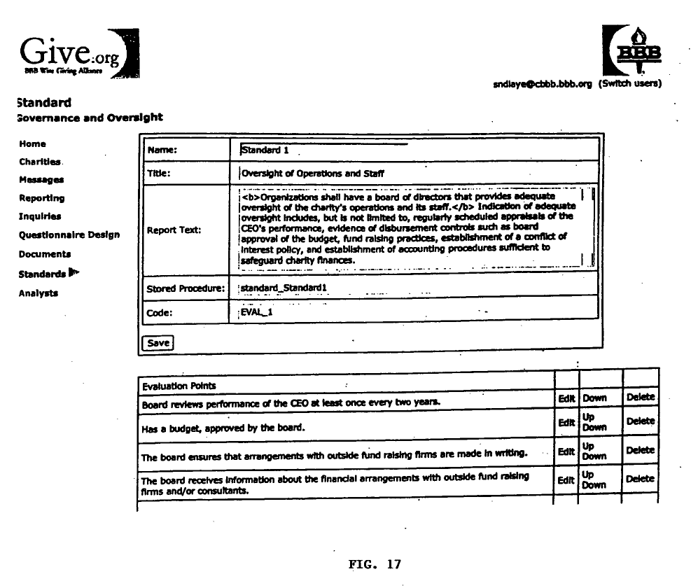

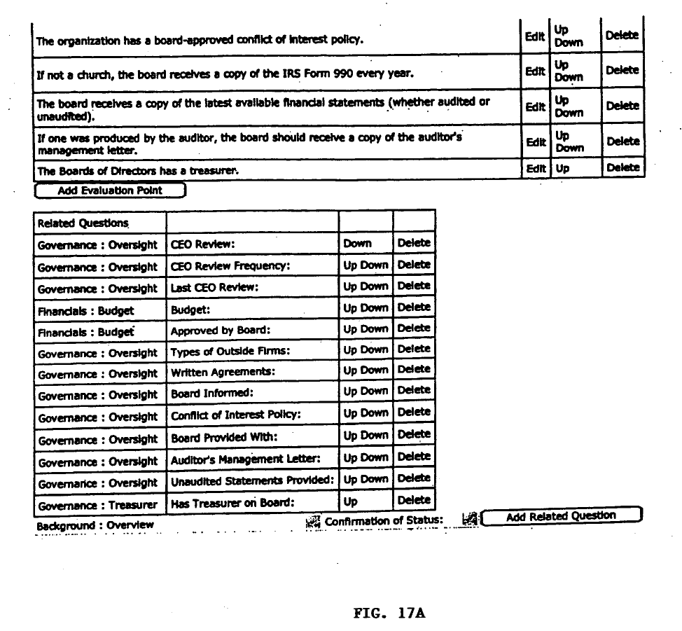

FIGS. 8 and 8A are logical flowchart diagrams illustrating an exemplary computer-implemented method for automatic evaluations of submitted responses to questionnaires against one or more standards as completed by step 240 of FIG. 2. Now referring to FIGS. 1, 2, and 8, the exemplary method 240 begins with the QAV 135 confirming that required answers were submitted in the response submitted and stored in the ODS 160. In step 804, an inquiry is conducted to determine if there are any required answers that are missing. In one exemplary embodiment, the questionnaire contains only a few questions that are required. The exemplary system has the capability to conduct the automated evaluation if only a portion of the questionnaire has been completed by a charity or organization, marking standards as incomplete if enough information has not been provided or enough answers have not been provided. If a required question has not been answered, the “Yes” branch is followed to the END step. Otherwise, the “No” branch is followed to step 806, where counter variable M, which represents a standard, is set equal to one. The AEP 140 retrieves the first standard from the QSDS 155 in step 808. In step 810, counter variable EP, which represents an evaluation point for standard M, is set equal to one. The evaluation points typically correspond to answers provided in the submitted response. FIGS. 17 and 17A illustrate an exemplary standard and corresponding evaluation points for the automatic evaluation. The exemplary standard of FIG. 17 is the Oversight of Operations and Staff. For the exemplary standard of FIG. 17, nine evaluation points are provided in FIGS. 17 and 17A, including “Board reviews performance of the CEO at least once every two years” and “Has a budget, approved by the board.” FIG. 17A also provides an exemplary illustration of questions that have been flagged as being related to the standard.

The AEP 140 analyzes the first evaluation point for the first standard in step 812 by comparing the first evaluation point in the standard to a corresponding answer in the submitted response. In step 814, the AEP 140 determines if the evaluation point does not apply. An evaluation point does not apply if it is for a standard that is no longer in effect or has not yet gone into effect. For example, consider if standard one is only used for evaluation purposes for submissions made in the 2004 calendar year. If a submission is made in the 2005 calendar year, then the evaluation points for standard one would not apply in evaluating a submission made in 2005. If the first evaluation point for the first standard does not apply, the “No” branch is followed to step 832. Otherwise, the “Yes” branch is followed to step 818.

An inquiry is conducted by the AEP 140 to determine if the first evaluation point in the submitted response is incomplete in step 818. An evaluation point is incomplete if the information provided in the responses submitted and stored in the ODS 160 does not provide enough information to determine if the charity meets the evaluation points for a standard. If the first evaluation point for the first standard is incomplete, the “Yes” branch is followed to step 820, where the AEP 140 records the first evaluation point as incomplete in the ODS 160. The process then continues to step 832. If, on the other hand, the first evaluation point is incomplete, the “No” branch is followed to step 822.

An inquiry is conducted to determine if the AEP 140 should mark the first evaluation point for review in step 822. An evaluation point that is marked for review can typically be manually reviewed at a later time by an administrator or evaluator via the evaluation workstation 170. In one exemplary embodiment, the exemplary system 100 marks evaluation points for review when the system 100 is not able to verify if the charity meets the evaluation point because of insufficient information, internal consistency or because human judgment is needed for the determination. If the evaluation point should be marked for review, the “Yes” branch is followed to step 824, where the AEP 140 marks the first evaluation point for review in the submitted response. The process then continues to step 832. However, if the evaluation point should not be marked for review, the “No” branch is followed to step 826, where an inquiry is conducted to determine if the charity satisfies the first evaluation point. If the first evaluation point does satisfy the first standard, the “Yes” branch is followed to step 828, where the AEP 140 records the evaluation point as satisfying the standard in the ODS 155. Otherwise, the “No” branch is followed to step 830, where the AEP 140 records the evaluation point as not satisfying the standard in the ODS 160.

In step 832, an inquiry is conducted to determine if there is another evaluation point for the first standard. If so, the counter variable N is incremented by one and the process returns to step 812 so that the AEP 140 can evaluate the next evaluation point. Otherwise, the “No” branch is followed to step 836 of FIG. 8A. In step 836, the AEP 140 conducts an inquiry to determine if at least one evaluation point for the first standard was incomplete. The AEP 140 typically reviews information it recorded in the ODS 160 to make this determination. If at least one evaluation point was incomplete, the “Yes” branch is followed to step 838, where the AEP 140 generates a message that incomplete information has been provided for evaluation of the first standard and records the message in the ODS 160. The process then continues to step 854. If there were not incomplete evaluation points for the first standard, the “No” branch is followed to step 840.

In step 840, an inquiry is conducted by the AEP 140 to determine if at least one evaluation point for the first standard did not meet the standard. If so, the “Yes” branch is followed to step 842, where the AEP 140 generates a message that the submitted response does not meet the standard and records the message in the ODS 160. The process then continues to step 854. However, if none of the evaluation points were determined to not meet the standard, the “No” branch is followed to step 844, where the AEP 140 determines if any of the evaluation points for the first standard were marked for review. If so, the “Yes” branch is followed to step 846, where the AEP 140 generates a message that the standard has been flagged for manual review and stores the message in the ODS 160. The process then continues to step 854. If, on the other hand, no evaluation points were marked for review, the “No” branch is followed to step 848.

In step 848, the AEP 140 conducts an inquiry to determine if all of the evaluation points for the first standard did not apply. If so, the “Yes” branch is followed to step 850, where the AEP 140 generates a message that the first standard does not apply and records the message in the ODS 160. The process then continues to step 854. If one or more of the evaluation points did apply, the “No” branch is followed to step 852, where the AEP 140 generates a message that the submission meets the requirements for the first standard and stores the message in the ODS 160. An inquiry is conducted in step 854 to determine if there are additional standards to review. The AEP 140 typically makes this determination by reviewing the standards stored in the QSDS 155. If there are additional standards to evaluate, the “Yes” branch is followed to step 856, where the counter variable M is incremented by one. The process then continues to step 808 of FIG. 8. If, on the other hand, there are no additional standards to review, the “No” branch is followed to step 245 of FIG. 2.

FIG. 9 is a logical flowchart diagram illustrating an exemplary computer-implemented method for conducting a secondary review and update of responses to the questionnaire as completed by step 245 of FIG. 2. Now referring to FIGS. 1, 2, and 9, the exemplary method 245 begins with the AEPS 125 displaying an automated evaluation and an effective evaluation, if any exist, on the evaluation workstation 170. An effective evaluation typically includes a modified version of the automated evaluation in which changes have been made by an analyst or administrator via the evaluation workstation 170. When an AEP 140 conducts an automated evaluation, it can save the results as two separate files, the automated evaluation and the effective evaluation. However, in one exemplary embodiment, if an analyst or administration wishes to make changes to an evaluation, changes can only be made to the effective evaluation.

In step 904 a standard is selected. A counter variable N representing an evaluation point for the standard M is set equal to one in step 906. In step 908, the AEPS 125 displays the automatic evaluation for standard M at the evaluation workstation 170. The AEPS 125 displays the effective evaluation for standard M at the evaluation workstation 170 in step 910. In step 912, the AEPS 125 displays the evaluation point record for the first evaluation point, retrieved from the ODS 160. In step 914, an inquiry is conducted to determine if standard M has another evaluation point record in the ODS 160. The AEPS 125 typically reviews the ODS 160 to determine if additional evaluation point records exist. If so, the “Yes” branch is followed to step 916, where the counter variable N is incremented by one. The process then returns to step 912. Otherwise, the “No” branch is followed to step 918, where the OQ 120 retrieves all of the questions related to the standard M from the QSDS 155 and their answers from ODS 160 and displays them at the evaluation workstation 170. Questions are typically related to one another if they are each evaluated in order to determine if a specific standard has been met. By designating questions as being related to one another, answers to the related questions can be quickly retrieved and displayed at the evaluation workstation 170.

In step 920, an inquiry is conducted to determine if the analyst or administrator wants to modify the effective evaluation in the ODS 160 for standard M. If so, the “Yes” branch is followed to step 922, where a modified effective evaluation is received from the evaluation workstation 170 at the AEPS 125. The AEPS 125 stores the modified effective evaluation in the ODS 160 in step 924. The process then returns to step 908. In one exemplary embodiment, an analyst might want to modify the effective evaluation when evaluation points for the standard have been marked for review. Once the analyst has had an opportunity to review the evaluation points and the charity's responses to questions related to the standard, the analyst could manually input a different record as to whether the charity satisfied the standard.

Returning to step 920, if no modifications are made to the effective evaluation, the “No” branch is followed to 926, where the AEPS 125 conducts an evaluation to determine if the effective evaluation meets standard M. If the effective evaluation is recorded as meeting the standard in the ODS 160, the “Yes” branch is followed to step 940. Otherwise, the “No” branch is followed to step 928, where the AEPS 125 conducts an inquiry to determine if the ODS 160 contains custom language explaining why the charity did not meet the standard. If it does not have custom language, the “No” branch is followed to step 930, where the ARP 145 generates the “does not meet” language for the evaluation report. Otherwise, the “Yes” branch is followed to step 932, where the AEPS displays the custom “does not meet” language generated at the evaluation workstation 170.

In step 934, an inquiry is conducted to determine if an analyst or administrator wants to modify the custom “does not meet” language. If so, the “Yes” branch is followed to step 936, where the modified language is received at the ARP 145 from the evaluation workstation 170. The modified “does not meet” language can then be stored by the ARP 145 in the ODS 160. If there is no change to the custom “does not meet” language, the “No” branch is followed to step 940, where an inquiry is conducted to determine if another standard will be selected. If so, the “Yes” branch is followed to step 904, where another standard is selected. Otherwise, the “No” branch is followed to step 250 of FIG. 2.

FIG. 10 is a logical flowchart diagram illustrating an exemplary computer-implemented method for generating a report of the evaluation of responses to the questionnaire as completed by step 250 of FIG. 2. Now referring to FIGS. 1, 2, and 10, the exemplary method 250 begins with a counter variable X, representing the number of standards that are met, being set equal to zero and a counter variable Y, representing the number of standards that are not met by the responses, being set equal to zero in step 1002. In step 1004, a request for a report is received by the ARP 145 from evaluation workstation 170.

The ARP 145 evaluates the effective evaluation stored in the ODS 160 to determine if any of the standards are flagged for review in step 1006. In step 1008, an inquiry is conducted to determine if any standards in the effective evaluation are flagged for review. If so, the “Yes” branch is followed to step 1010, where the ARP 145 generates a message that an evaluation report cannot be generated and displays the message on the evaluation workstation 170. Otherwise, the “No” branch is followed to step 1012, where the ARP 145 retrieves basic information about the charity being evaluated from the ODS 160 and inserts the basic information into a report template. In one exemplary embodiment, basic information about the charity can include the name of the charity, its address, the state the charity is incorporated in, and any affiliates of the corporation. In another exemplary embodiment, the basic information about the charity can include governance and financial information about the charity and custom information inserted into the report by an analyst or administrator.

In step 1014, a counter variable M, representing the standards, is set equal to one. In step 1016, an inquiry is conducted to determine if the first standard is met in the effective evaluation. In one exemplary embodiment, the ARP 145 retrieves the effective evaluation from the ODS 160 to determine the evaluation as compared to the standards. If the standard is met in the effective evaluation, the “Yes” branch is followed to step 1034. Otherwise, the “No” branch is followed to step 1018, where the ARP 145 conducts an inquiry to determine if the first standard does not apply in the effective evaluation. In one exemplary embodiment, a standard does not apply if all of the evaluation points related to the standard do not apply. If the first standard does not apply in the effective evaluation, the “Yes” branch is followed to 1034, where the counter variable X is incremented by one. The process continues to step 1038. If the first standard does apply in the effective evaluation, the “No” branch is followed to step 1020, where the ARP 145 generates language that the charity does not meet the first standard and adds the language into the report template.

In step 1022, the ARP 145 conducts an inquiry to determine if basic “does not meet” language should be used for the charity's failure to meet the first standard (basic “does not meet” language should be used if no custom “does not meet” language has been provided for the charity for that standard). Each evaluation point contains a template for basic “does not meet” language that should be used if the charity does not meet that evaluation point; this template is typically stored in the QSDS 155. If basic language is used, the “Yes” branch is followed to step 1024, where the ARP 145 retrieves from the QSDS 155 the templates for the one or more evaluation points that the charity did not meet within the first standard, and from the ODS 160 the responses to the questionnaire that are relevant to the standard. In step 1026, the ARP 145 generates an explanation of how the charity failed to meet the standard by combining the retrieved questionnaire responses with the template “does not meet” language for the retrieved evaluation point(s) that the charity did not satisfy in the first standard. In step 1028, the ARP 145 inserts the generated language into the report template. Returning to step 1022, if basic “does not meet” language is not used, the “No” branch is followed to step 1030.

In step 1030, the ARP 145 retrieves the custom “does not meet” language for the first standard from the ODS 160 and inserts it into the report template in step 1032. In step 1036, the counter variable Y is incremented by one. An inquiry is conducted by the ARP 145 to determine if another standard was evaluated for this charity in step 1038. If so, the “Yes” branch is followed to step 1040, where the counter variable M is incremented by one. The process then returns to step 1016. Otherwise, the “No” branch is followed to step 1042.

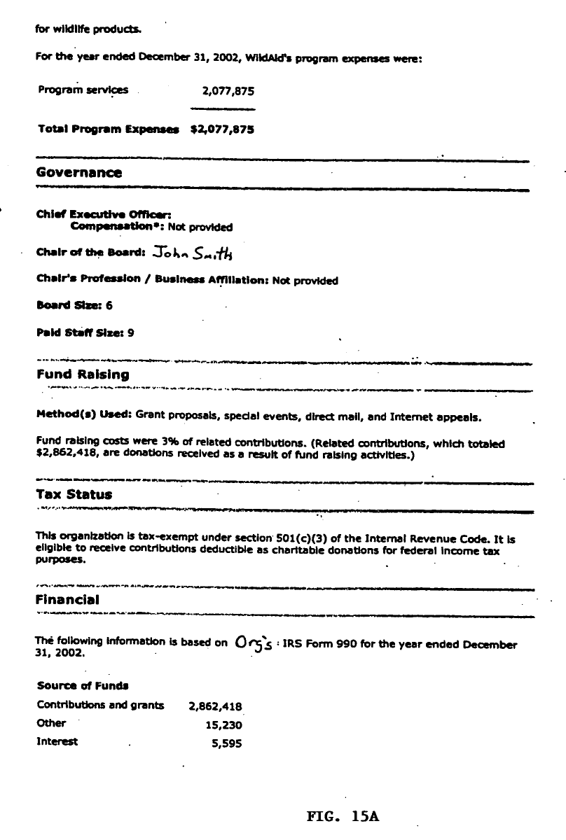

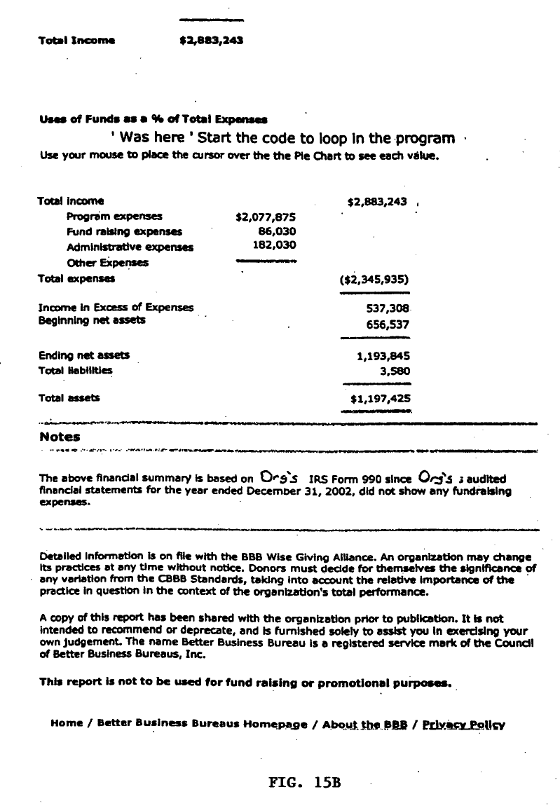

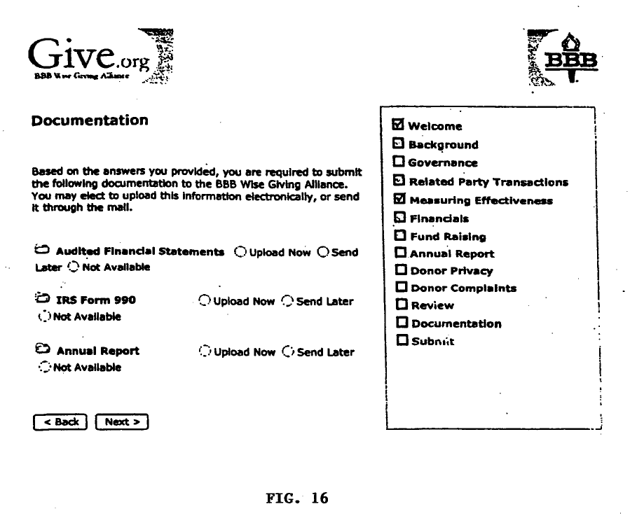

In step 1042, the ARP 145 conducts an inquiry to determine if all standards were either met or did not apply. If so, the “Yes” branch is followed to step 1044, where the ARP 145 generates a statement that the charity meets all standards and inserts it into the report template. Otherwise, the “No” branch is followed to step 1046, where the ARP adds the counter variables X and Y into the report template to designate the number of standards a charity did and did not meet. FIGS. 15-15B illustrate an exemplary report generated by the ARP 145. In the exemplary report of FIG. 15, background information of the charity is provided along with a review of the evaluation, including standards that were not met by the charity. The exemplary report of FIGS. 15A and 15B provide responses given by the charity, including financial information and how funds were used by the charity. The ARP 145 can store the report in the RDS 165 in step 1048. The process can then continue to step 255 of FIG. 2.

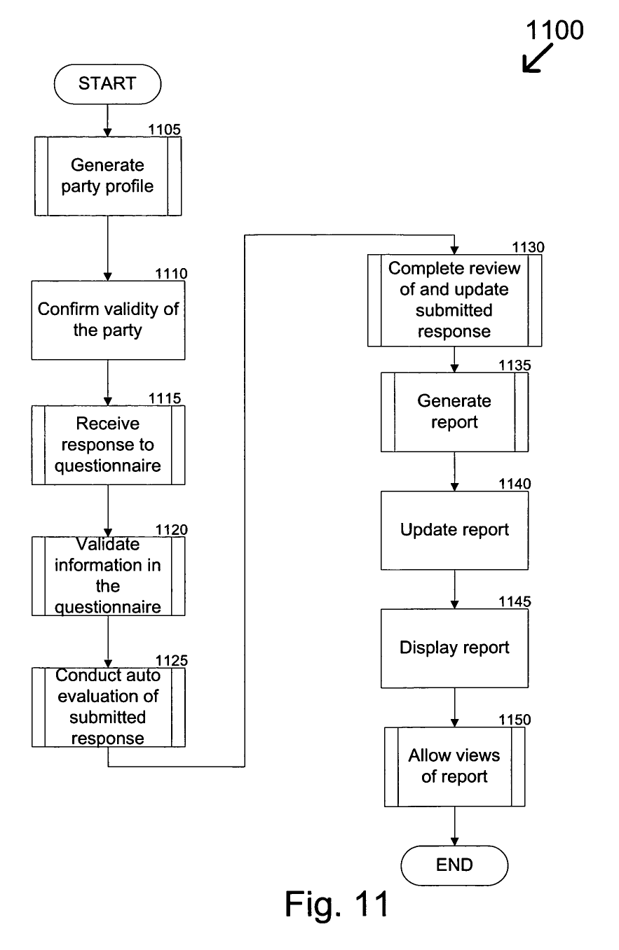

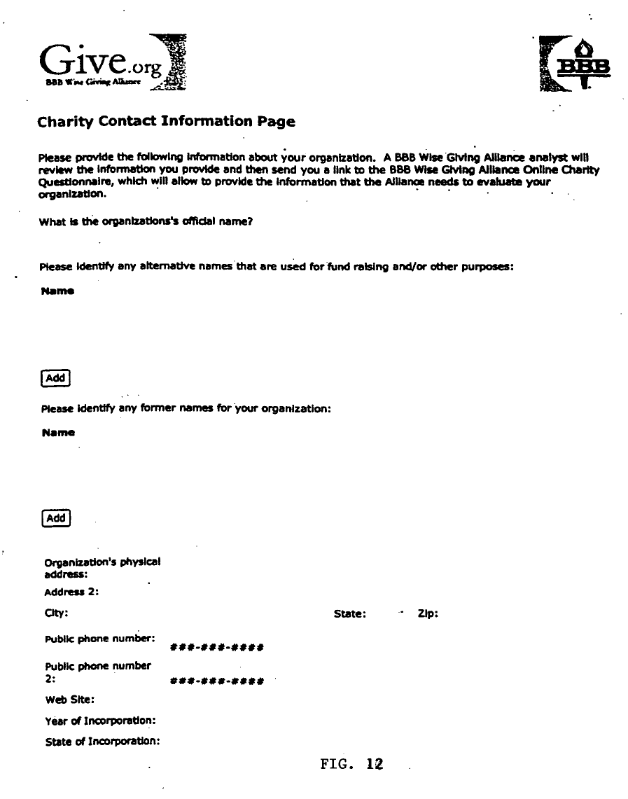

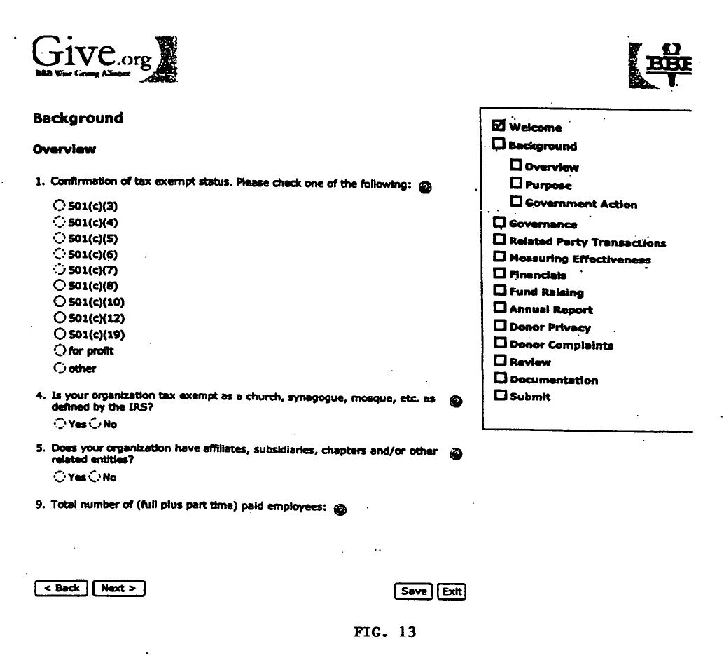

FIG. 11 is a logical flowchart diagram illustrating an alternative exemplary embodiment 1100 for receiving and evaluating information provided in a response to an online organizational questionnaire, within the operating environment of the exemplary automated evaluation system 100 of FIG. 1. Now referring to FIGS. 1 and 11, the exemplary method 1100 begins at the START step and proceeds to step 1105, in which a party profile is generated. In one exemplary embodiment, an organizational profile can be generated by an analyst or administrator at the CRS 115, via the evaluation workstation 170. The organizational profile is typically stored in the ODS 160, and can include the name of the charity that is registering, an email address or other contact information, and a password for subsequent entry into the system 100. In step 1110, the validity of the registering charity is verified. The verification of a charity typically includes determining if the charity is a soliciting organization. Validation of a charity can be completed by matching information maintained in databases or by manual review. In one exemplary embodiment, the CRS 115 passes registration information from the ODS 160 to the evaluation workstation 170, where an analyst determines validation of a charity or an administrator verifies if the charity is a soliciting organization.

In step 1115, the automated evaluation system 100 receives a response to the questionnaire from an analyst or administrator inputting information from the evaluation workstation 170 at the OQ 120. The QAV 135 in step 1120 validates information contained in the response. In step 1125, the AEP 140 conducts an automatic evaluation of the response to determine if the response meets the standards stored in the QSDS 155. A backup review and revision of submitted responses can be received from the evaluation workstation 170 through AEPS 125 in step 1130. The ARP 145 in step 1135 can generate a report. The report typically includes the responses provided by the analyst or administrator in step 1115, the standards the responses were compared to and whether the charity met, failed to meet, or did not provide enough information to determine if the charity met the standard. In step 1140, the report can be updated or modified. In one exemplary embodiment, the report is modified by an analyst through the evaluation workstation 170 and the AEPS 125. The modified report is displayed on the evaluation workstation 170 in step 1145. In step 1150, the report can be stored in the RDS 165 and can be viewed by the workstation 175 by making a request through the WPWS 130. The process continues to the END step.

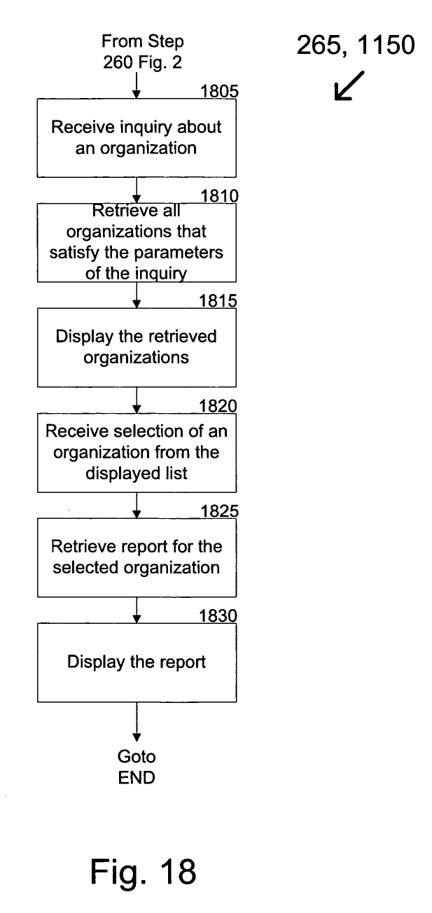

FIG. 18 is a logical flowchart diagram illustrating an exemplary computer-implemented method for displaying a report on a charity in response to a request as completed by step 265 of FIG. 2. Now referring to FIGS. 1, 2, and 18, the exemplary method 265 begins with the WPWS 130 receiving an inquiry about a charity or an aspect of a charity in step 1805. In one exemplary embodiment, the inquiry is received from the workstation 175 via the Internet 180 and can include the name of the charity, state address, the state or incorporation, a URL, or other identifying feature of one or more charities. In step 1810, the WPWS 130 retrieves the charity or charities matching the inquiry from RDS 165.

Charities having information that match the inquiry are displayed on the workstation 175 by the WPWS 130 in step 1815. In step 1820, a selection is received at the WPWS 130 from the workstation 175. The selection typically consists of one particular charity that the inquirer wants information about. The WPWS 130 retrieves the report for the selected charity from the RDS 165 in step 1825. In step 1830, the WPWS 130 transmits the report to the workstation 175 to be displayed. The process continues to the END step.

In conclusion, the present invention supports a computer-implemented method for receiving information about an organization and automatically evaluating the organization against one or more standards. It will be appreciated that the present invention fulfills the needs of the prior art described herein and meets the above-stated objectives. While there have been shown and described several exemplary embodiments of the present invention, it will be evident to those skilled in the art that various modifications and changes may be made thereto without departing from the spirit and the scope of the present invention as set forth in the appended claims and equivalence thereof.

We claim:

1. A computer-implemented method for evaluating a response to an online questionnaire, comprising the steps of:
receiving a first online response from an organization to the online questionnaire comprising a first plurality of questions, wherein the response comprises a plurality of answers to at least one of the questions;
conducting a validation check of the answers in the response to determine if at least one error exists in at least one answer, wherein an error comprises an answer to a first question and an answer to a second question being inconsistent;
completing an automated evaluation of the answers in the response against at least one standard to determine if the standard has been met, the automated evaluation comprising the steps of:
a. retrieving a first standard from a plurality of standards stored in a database;
b. retrieving a first answer from the plurality of answers in the response; and
c. comparing the first answer to the first standard to determine if the first standard has been met; and
generating a report in an online environment, the report comprising a summary of the automated evaluation and information about the organization.

2. The computer-implemented method of claim 1 further comprising the steps of:
receiving an online request from the organization to provide the response to the questionnaire;
generating a user interface comprising a second plurality of questions to obtain background information about the organization;
receiving a second online response comprising the background information of the organization;
receiving login information comprising a password and an e-mail address for the organization;
determining if the e-mail address was previously received from a second organization; and
if the e-mail address was not previously received from a second organization, storing the login information and the second online response.

3. The computer-implemented method of claim 2 further comprising the step of determining if the organization sending the online request is a soliciting non-profit organization.

4. The computer-implemented method of claim 1, wherein the step of receiving a first online response from an organization to the online questionnaire further comprises the steps of:
retrieving a first page of questions from a database, wherein the first page of questions comprises at least one question;
displaying the first page of questions at the user interface;
receiving an answer to a first question on the first page of questions;
determining if the format of the answer is improper by comparing a form of the answer anticipated against the form of the answer received;
if the format of the answer is proper then determining if an additional question is associated with the first question;
if an additional question is not associated with the first question, then storing the answer in the database;
receiving a request to display a second page of questions at the user interface;
displaying the second page of questions on the user interface; and
storing at least one answer to at least one question on the first page of questions in a database.

5. The computer-implemented method of claim 4 further comprising the steps of:
receiving login information comprising a first password and a first e-mail address;
comparing the login information to a plurality of login data in a database, to determine if the proper login information has been received, each login data comprising a password and an e-mail address and the login data being proper if it matches at least one login data; and
displaying the online questionnaire on the user interface if the proper login information has been received.

6. The computer-implemented method of claim 4 further comprising the steps of:
determining if a prior response to the online questionnaire comprising at least one answer was received from the organization;
if the prior response to the questionnaire was received, then retrieving the prior response from the database; and
inserting at least one answer from the prior response into an answer position of at least one question in the online questionnaire.

7. The computer-implemented method of claim 4 further comprising the steps of:
if additional questions are associated with the question, then determining if the answer provided in response to the question requires at least one follow-up question;
retrieving at least one follow-up question if the answer provided to the question requires at least one follow-up question; and
displaying at least one follow up question on the first page of questions.

8. The computer-implemented method of claim 4 further comprising the steps of:
determining if the end of the questionnaire has been reached; and
if the end of the questionnaire has been reached, then transmitting at least one answer to an evaluation component for evaluation against at least one standard.

9. The computer-implemented method of claim 1, wherein the step of completing an automated evaluation further comprises the steps of:
a. retrieving a first evaluation point from the at least one evaluation point in the first standard;
b. comparing the first evaluation point to the first answer to determine if a first requirement for the first evaluation point has been met;
c. repeating steps (a)-(b) for each additional evaluation point in the first standard;
d. recording a first evaluation for the first standard; and
e. repeating steps (a)-(d) for each of the plurality of standards.

10. The computer-implemented method of claim 9, wherein determining if a first requirement for a first evaluation point has been met further comprises the steps of:
determining if the first evaluation point does not apply to the organization;
if the first evaluation point does not apply to the organization, then storing a first message that the first evaluation point does not apply;
if the first evaluation point does apply to the organization, then determining if the first answer associated with the first evaluation point is incomplete;
if the first answer associated with the first evaluation point is incomplete, then storing a second message that the first evaluation point is incomplete;
if the first answer is not incomplete, then determining if the first evaluation point should be flagged for review;
if the first evaluation point should be flagged for review, then generating a flag associated with the first evaluation point in the response;
if the first answer should not be flagged for review, then determining if the first answer meets the first requirement for the first evaluation point;
if the first answer does not meet the first requirement for the first evaluation point, then storing a third message that the organization does not meet the first evaluation point for the first standard; and
if the first answer does meet the first requirement for the first evaluation point, then storing a fourth message that the organization does meet the first evaluation point for the first standard.

11. The computer-implemented method of claim 10, wherein recording a first evaluation for a first standard further comprises the steps of:
determining if at least one evaluation point for the first standard is incomplete;
if at least one evaluation point is incomplete, then recording a fifth message comprising language that the evaluation of the first standard is incomplete;
if none of the evaluation points is incomplete, then determining if the organization did not meet at least one evaluation point in the first standard;
if the organization did not meet at least one evaluation point in the first standard, then recording a sixth message comprising language that the first standard has not been met;
if there were no evaluation points in the first standard that the organization did not meet, then determining if at least one of the evaluation points was flagged for review;
if at least one of the evaluation points for the first standard was flagged for review, then recording a seventh message comprising language that the first standard has been flagged for review;
if none of the evaluation points for the first standard was flagged for review, then determining if all of the evaluation points for the first standard do not apply;
if all of the evaluation points for the first standard do not apply, then generating an eighth message comprising language that the first standard does not apply; and
if not all of the evaluation points for the first standard did not apply, then generating a ninth message comprising language that the first standard has been met.

12. The computer-implemented method of claim 9, wherein the step of generating a report further comprises the steps of:
a. retrieving a report template from a database;
b. retrieving a background information about the organization from a database;
c. inserting the background information into the report template;
d. retrieving the first standard of at least one standard;
e. determining if the first standard was met in the evaluation of the answers in the response;
f. if the first standard was not met, then determining if the first standard does not apply to the evaluation of the answers in the response;
g. if the first standard does apply, then retrieving a first description comprising language that the first standard has not been met;
h. retrieving at least one answer associated with the first evaluation point that did not meet the first standard;
i. inserting the at least one answer retrieved and the first description into the report template;
j. repeating steps (d)-(i) for each of the at least one standard; and
k. storing the report template in a database.

13. The computer-implemented method of claim 12 further comprising the steps of:
incrementing a first counter variable for each standard of the at least one standard that has not been met;
incrementing a second counter variable for each standard of the at least one standard that has been met; and
inserting the first counter variable and the second counter variable into the report template.

14. The computer-implemented method of claim 12 further comprising the steps of:
receiving a custom description comprising customized language that the first standard has not been met; and
inserting the at least one answer retrieved and the custom description into the report template.

15. The computer-implemented method of claim 9, wherein the step of generating a report further comprises the steps of:
a. retrieving a report template from a database;
b. retrieving a background information about the organization from a database;
c. inserting the background information into the report template;
d. retrieving the first standard of at least one standard;
e. determining if the first standard was met in the evaluation of the answers in the response;
f. if the first standard was met, then repeating steps (d)-(e) for each of the at least one standard;
g. retrieving a second description comprising language that the all standards have been met; and
h. storing the report template in a database.

16. A computer-implemented method for evaluating a first set of organization-related data in a database comprising the steps of:
retrieving the first set of organization-related data from a database, the organization-related data comprising background information on an organization, financial information, governance, complaint history, and source of funding;
conducting a validation check on the first set of organizational data to verify that the first set of organizational data satisfies a minimum threshold for data completeness;
completing an automated evaluation of the organization by evaluating the first set of organizational data against a plurality of standards to determine if each of the plurality of standards has been met; and
generating a report comprising a summary of the evaluation and the first set of organizational data; the report presenting a conclusion of whether the organization conducts business in a manner that complies with the plurality of standards.

17. The computer-implemented method of claim 16, wherein the step of completing an automated evaluation further comprises the steps of:
a. retrieving a first evaluation point from at least one evaluation point in a first standard;
b. retrieving a first data entry in the first set of organizational data
c. determining if the first data point associated with the first evaluation point is incomplete;
d. if the first data point is complete, then determining if the first data point meets a requirement for the first evaluation point, the requirement comprising a level the data point must satisfy in order to satisfy the standard;
e. repeating steps (a)-(c) for each additional evaluation point in the first standard;
f. recording a first evaluation for the first standard, the first evaluation comprising a determination that the standard was met, was not met, did not apply, or was incomplete; and
g. repeating steps (a)-(d) for each of the plurality of standards.

18. The computer-implemented method of claim 16, wherein the step of generating a report further comprises the steps of:
a. retrieving a report template from a database;
b. retrieving the background information on the organization from the first set of organizational data;
c. inserting the background information into the report template;
d. retrieving a first of the plurality of standards;
e. determining if the first standard was met in the evaluation of the first set of organizational data;
f. if the first standard was not met, then determining if the first standard does not apply to the first set of organizational data;
g. if the first standard does apply, then retrieving a first description comprising language that the first standard has not been met;
h. retrieving at least one data entry in the first set of organizational data associated with the first standard that has not been met;
i. inserting the at least one data entry retrieved and the first description into the report template;
j. repeating steps (d)-(i) for each of the at least one standard; and
k. displaying the report on an online user interface.

19. A computer-implemented method for an online automated evaluation of a charity against a plurality of standards comprising the steps of:
receiving an online request from the charity to receive the evaluation by providing a first online response to an online questionnaire, the request comprising a name of the charity, contact information for the charity, and a password;
receiving the first online response from the charity, the first online response comprising at least one answer to at least one question in the online questionnaire; and
completing an automated evaluation of the answers in the response against at least one standard to determine if the standard has been met, the automated evaluation comprising the steps of:
a. retrieving a first standard from a plurality of standards stored in a database;
b. retrieving a first answer associated with the first standard from at least one answer in the first online response, wherein an answer is associated with a standard when the standard comprises an evaluation of the answer;
c. determining if the first standard does not apply to the first answer;
d. if the first standard does apply to the first answer, then determining if the first answer is complete;
e. if the first answer is complete, then comparing the first answer to the first standard to determine if the first standard has been met; and
f. repeating steps (a)-(e) for each standard used to evaluate the first online response of the charity.

20. The computer-implemented method of claim 19 further comprising the steps of automatically generating an online accessible report of the evaluation of the charity comprising;
background information of the charity comprising the name of the charity and the contact information of the charity;
a summary of the automated evaluation comprising:
if at least one standard was not met in the automated evaluation, a message comprising a listing of the standards that were not met and at least one answer provided by the charity in the first online response that is associated with each standard that was not met;
if all standards were met in the automated evaluation, a message that all standards have been met; and
a summary of the first online response for the charity.

21. The computer-implemented method of claim 19 further comprising the step of determining if the charity sending the online request is a soliciting organization.

22. The computer-implemented method of claim 19 further comprising the steps of:
receiving login information comprising a first password and a first e-mail address for the charity;
comparing the login information to a plurality of login data in a database, to determine if the proper login information has been received from the charity, each login data comprising a password and an e-mail address for a charity and the login data being proper if it matches at least one login data; and
displaying the online questionnaire on a user interface if the proper login information has been received.

23. The computer-implemented method of claim 19 further comprising the steps of:
determining if a prior response to the online questionnaire comprising at least one answer was received from the charity;
if the prior response to the questionnaire was received, then retrieving the prior response from the database; and
inserting at least one answer from the prior response into an answer position of at least one question in the online questionnaire.

24. The computer-implemented method of claim 19 further comprising the steps of:
determining if at least one answer associated with the first standard is incomplete;
if at least one answer is incomplete, then recording a first message comprising language that the evaluation of the first standard is incomplete;
if none of the answers associated with the first standard are incomplete, then determining if at least one answer did not meet at least one evaluation point for the first standard;
if at least one answer did not meet at least one evaluation point for the first standard, then recording a second message comprising language that the first standard has not been met;
if none of the answers did not meet at least one evaluation point for the first standard, then, determining if at least one of the evaluation points was flagged for review;
if at least one evaluation point was flagged for review, then recording a third message comprising language that the first standard has been flagged for review;
if none of the evaluation points for the first standard were flagged for review, then determining if all of the evaluation points for the first standard do not apply;
if all of the evaluation points for the first standard do not apply, then generating an fourth message comprising language that the first standard does not apply; and
if not all of the evaluation points for the first standard did not apply, then generating a fifth message comprising language that the first standard has been met.
